(19) United States
(12) Patent Application Publication
(10) Pub. No.: US 2026/0032021 A1
(43) Pub. Date: Jan. 29, 2026

(54) CHANNEL STATE INFORMATION PREDICTION USING MACHINE LEARNING

(71) Applicant: Telefonaktiebolaget LM Ericsson (publ), Stockholm (SE)

(72) Inventors: Heunchul LEE, Täby (SE); Jaeseong JEONG, Solna (SE); Mattias FRENNE, Uppsala (SE)

(21) Appl. No.: 18/994,480

(22) PCT Filed: Jul. 15, 2023
(86) PCT No.: PCT/EP2023/066132

§ 371 Date: Jan. 14, 2025

Related U.S. Application Data
(60) Provisional application No. 63/389,400, filed on Jul. 15, 2022.

(51) Int. Cl. H04L 25/02

(52) U.S. Cl. CPC H04L 25/0254

(57) ABSTRACT

A method is performed by a network node for precoding of downlink communications predicting downlink channel state. The method receives a compressed-dimensional representation of a channel state that is encoded through an encoder neural network of a UE. The method maps the compressed-dimensional representation through a forward-prediction neural network to generate a compressed-dimensional predicted representation of a forward channel state at least one step forward in time k+Δ, wherein Δ is a number of steps forward in time. The method decodes the compressed-dimensional predicted representation of the forward channel state through a decoding neural network to generate an increased-dimensional predicted representation of the forward channel state, where the increased-dimensional predicted representation is a higher dimensional representation than the compressed-dimensional predicted representation. The method precodes signals for transmission through the downlink channel to the UE based on the increased-dimensional predicted representation of the forward channel state.

### TECHNICAL FIELD

The present disclosure relates generally to communications, and more particularly to communication methods and related devices and nodes supporting wireless communications.

### BACKGROUND

When channel reciprocity of fast fading cannot be utilized, such as in frequency division duplexing (FDD) systems, the downlink channel state information (CSI) is estimated at the user equipment (UE) based on reference signals (RS) transmitted from the network, and the estimated CSI is sent to the base station (BS) through a feedback signal in uplink. This CSI is used for precoding design in downlink multi-antenna systems.

An autoencoder (AE) can be used as a dimensionality reduction/compression method for minimizing the feedback signal overhead, or to improve the performance at a maintained overhead compared to existing CSI reporting.

The encoder part of autoencoder is located on the UE side to compress channel data into a reduced dimensional space while its decoder part is applied on the BS side to reconstruct the original channel data from the compressed feedback.

The AE-based approaches have been the most popular approaches for the new Release-18 study on the ML-based CSI enhancements, including CSI compression such as disclosed in two references: [1] 3GPP RP-213499, “New SID: Study on Artificial Intelligence (AI)/Machine Learning (ML) for NR Air Interface,” 3GPP TSG RAN #94e, December 2021 (hereinafter “3GPP RP-213499”); and [2] C.-K. Wen, W.-T. Shih, and S. Jin, “Deep Learning for Massive MIMO CSI Feedback,” IEEE Wireless Communications Letters, vol. 7, pp. 748-751, October 2018 (hereinafter “CSINet”). The aim of existing machine learning (ML)-based CSI compression is to minimize signal overhead or reconstruction error through dimensionality reduction. However, it is inevitable that the performance of precoding design degrades due to channel aging even under the ML-based CSI compression, partly because there is always a non-zero latency between the measurement by the UE and when the report is available at the BS side. Hence, due to the time varying nature of the channel under user mobilities, it is said that the channel has “aged”. The performance loss due to the channel aging can be far more severe than the loss due to reconstruction error.

### SUMMARY

Some embodiments are directed to a method performed by a network node for precoding of downlink communications predicting downlink channel state. The method includes receiving, from a UE, a compressed-dimensional representation of a channel state generated from a multi-dimensional representation of a channel state at a time k that is encoded through an encoder neural network of the user equipment, wherein the multi-dimensional representation is a higher dimensional representation than the compressed-dimensional representation. The method maps the compressed-dimensional representation of the channel state through a forward-prediction neural network to generate a compressed-dimensional predicted representation of a forward channel state at least one step forward in time k+Δ, wherein Δ is a number of steps forward in time. The method decodes the compressed-dimensional predicted representation of the forward channel state through a decoding neural network to generate an increased-dimensional predicted representation of the forward channel state, wherein the increased-dimensional predicted representation is a higher dimensional representation than the compressed-dimensional predicted representation. The method precodes signals for transmission through the downlink channel to the user equipment based on the increased-dimensional predicted representation of the forward channel state.

Some other embodiments of the present disclosure are directed to a method performed by a UE for predicting downlink channel state. The method includes obtaining a multi-dimensional representation of a channel state based on channel estimations of signals received from at least one network node. The method encodes the multi-dimensional representation of the channel state through an encoder neural network to a compressed-dimensional representation of the channel state at a time k, wherein the multi-dimensional representation is a higher dimensional representation than the compressed-dimensional representation. The method maps the compressed-dimensional representation of the channel state at the time k through a forward-prediction neural network to generate a compressed-dimensional predicted representation of a forward channel state at least one step forward in time k+Δ, wherein Δ is a number of steps forward in time. The method sends the compressed-dimensional predicted representation of the forward channel state to one of the at least one network node.

Some other embodiments are directed to a network node for precoding of downlink communications predicting downlink channel state and are directed to a UE for predicting downlink channel state.

Numerous advantages and improvements may be provided by these and other embodiments disclosed herein. For example, unlike the AE-based CSI compression, which develops a compressed representation of channel data, the forward-prediction neural network in present embodiments can be configured to generate (predict) a representation of a compressed-dimensional representation of the forward channel state at least one step forward in time k+A by learning latent dynamics of the radio channel. Moreover, as explained below, the forward-prediction neural network can provide a representation of the channel dynamics of the forward channel state from radio channel images that can use 3GPP CSI feedback mechanisms and provide multi-step-ahead-in-time predictions based on e.g., single latent feedback. As a result, the forward-prediction neural network based forward channel state, e.g., CSI prediction, can provide an accurate multi-step-ahead-in-time prediction model for a dynamically changing radio channel under 3GPP CSI feedback mechanism.

### BRIEF DESCRIPTION OF THE DRAWINGS

The accompanying drawings, which are included to provide a further understanding of the disclosure and are incorporated in and constitute a part of this application, illustrate certain non-limiting embodiments of inventive concepts. In the drawings:

FIG. 1 illustrates a graph generated by simulations of percentage of upper-bound capacity as a function of CSI aging in slot time;

FIG. 2 illustrates a Release-18 CSI compression proposal based on autoencoder structure with encoder φ at the UE side and decoder φ⁻¹ at the base station (BS) side. The term PD is used as an abbreviation for precoded PDSCH;

FIG. 3 illustrates CSI prediction based on evoCSINet with an encoder neural network φ in the UE, and with a forward-prediction neural network (also called a dynamics process neural network) [symbol] and decoder neural network φ⁻¹ in the BS or other network node, in accordance with some embodiments of the present disclosure;

FIG. 4a illustrates a schematic diagram of one approach for AE-based CSI compression;

FIG. 4b illustrates a basic architecture of a evoCSINet-based CSI prediction according to some embodiments of the present disclosure;

FIG. 5a shows another basic architecture of the evoCSINet with three neural networks configured in accordance with some embodiments;

FIG. 5b shows the evoCSINet with three neural networks configured in accordance with some other embodiments to provide a multi-step-ahead prediction;

FIG. 5c shows the evoCSINet with three neural networks configured in accordance with still some other embodiments to provide a multi-step-ahead prediction;

FIG. 6 illustrates a block diagram of the encoder neural network φ, dynamics process neural network F, and decoder neural network φ⁻¹ being trained using examples of data samples, in accordance with some embodiments;

FIG. 7 illustrates a block diagram of the CSI prediction system in which the encoder neural network q and the dynamics process neural network [symbol] are located in the UE and the decoder neural network φ⁻¹ is located in the BS, or other network node, and configured for CSI prediction in accordance with some embodiments;

FIG. 8 illustrates another block diagram of the CSI prediction system in which the encoder neural network φ and the dynamics process neural network [symbol] are located in the UE and the decoder neural network φ⁻¹ is located in the BS, or other network node, and configured for multi-step ahead channel prediction in accordance with some embodiments;

FIG. 9 illustrates CSI RS configurations in single-slot mode in which the conditional input channel hₖ is generated by channel responses of conditional CSI-RSs from a single slot and the target output channels to be predicted in a recursive manner are given by channel responses of target CSI RSs from future slots, in accordance with some embodiments;

FIG. 10 illustrates CSI RS configurations in dual-slot mode (or aggregate mode) in which the conditional input channel \ddot{h}ₖ=[hₖ₋₁₀, hₖ] is generated by channel responses of conditional CSI-RSs from two slots and the target output channels hₖ₊ₘ for m=1, 2, . . . , 9, to be predicted in a recursive manner are given by channel responses of target CSI RSs from future slots, in accordance with some embodiments;

FIG. 11 illustrates a flowchart of operations that can performed by a UE in accordance with some embodiments;

FIG. 12 illustrates a flowchart of operations that can performed by a network node in accordance with some embodiments;

FIG. 13 is a block diagram of a communication system in accordance with some embodiments;

FIG. 14 is a block diagram of a user equipment in accordance with some embodiments

FIG. 15 is a block diagram of a network node in accordance with some embodiments;

FIG. 16 is a block diagram of a host computer communicating with a user equipment in accordance with some embodiments;

FIG. 17 is a block diagram of a virtualization environment in accordance with some embodiments; and

FIG. 18 is a block diagram of a host computer communicating via a base station with a user equipment over a partially wireless connection in accordance with some embodiments in accordance with some embodiments.

### DETAILED DESCRIPTION

Some of the embodiments contemplated herein will now be described more fully with reference to the accompanying drawings. Embodiments are provided by way of example to convey the scope of the subject matter to those skilled in the art, in which examples of embodiments of inventive concepts are shown. Inventive concepts may, however, be embodied in many different forms and should not be construed as limited to the embodiments set forth herein. Rather, these embodiments are provided so that this disclosure will be thorough and complete, and will fully convey the scope of present inventive concepts to those skilled in the art. It should also be noted that these embodiments are not mutually exclusive. Components from one embodiment may be tacitly assumed to be present/used in another embodiment.

At least some embodiments of the present disclosure are directed to providing operations and methods for an ML-based channel state information (CSI) prediction that allows accurate predictions of radio channel variations, i.e., prediction of downlink channel state, over time using 3GPP CSI feedback mechanisms.

Some embodiments are directed to a CSI framework, which is also referred to as evolutional CSINet (evoCSINet), that learns low-dimensional latent dynamics of radio propagation channel for prediction applications. The evoCSINet framework may use deep neural networks to identify latent dynamics from radio channel images. The latent dynamics may be used for a recursive multi-step prediction in latent space. The evoCSINet framework, in turn, may provide an accurate multi-step-ahead prediction model using 3GPP CSI feedback mechanisms.

In the forward link, pilot signals, commonly known as reference signals (RS) are transmitted from one node (base station or other network node) to another node (such as a user equipment (UE) or other network node) at a time-frequency grid of resource elements (REs) in multi-carrier slot-based system. Examples of such systems are 4G LTE, 5G NR or possibly in an upcoming 6G system.

The UE obtains the forward channel states in the form of multi-dimensional matrix through channel estimations based on the received pilot signals (RS), such as the CSI-RS.

The UE uses a first neural network model, called encoder φ, at time k, to transform the channel state to a low-dimensional representation at time k, called latent vector zₖ=φ(hₖ). The latent vector is sent to the BS through a feedback signal in the reverse link. The UE or BS applies a second neural network, called dynamicNet [symbol] , to map the latent vector one or multiple steps m>0 forward in time, zₖ₊₁= [symbol] (zₖ) Or zₖ₊ₘ= [symbol] ^{m}(zₖ). BS applies a third neural network, called decoder φ⁻¹, on the output of the dynamicNet, to obtain the channel state prediction from the latent prediction. Although some operational embodiments are described here and elsewhere as being performed by a BS, they are not limited thereto and may be performed by any other type of network node.

Some embodiments are directed to where dynamicNet ( [symbol] ) resides in the BS and is applied after receiving the output from the encoder (i.e., BS implementation). Some other alternative embodiments are directed to where dynamicNet ( [symbol] ) resides in the UE after the encoder, and is applied after receiving the output from the encoder and before transmitting the latent space variable to the BS (i.e. requires specification changes as BS may need to know that latent space variable represents a predicted (+Δ) value).

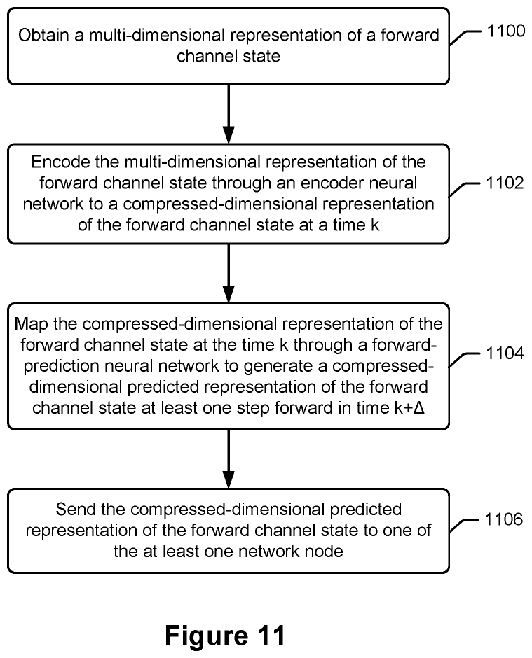

FIG. 11 illustrates a flowchart of operations that can be performed by a UE for predicting downlink channel state in accordance with some embodiments of the present disclosure. Referring to FIG. 11, the operations include obtaining 1100 a multi-dimensional representation of a forward channel state based on channel estimations of signals received from at least one network node, e.g., one or more BSs. The operations further include encoding 1102 the multi-dimensional representation of the forward channel state through an encoder neural network (e.g., first neural network model called encoder φ) to a compressed-dimensional representation of the forward channel state at a time k, wherein the multi-dimensional representation is a higher dimensional representation than the compressed-dimensional representation. The operations further include mapping 1104 the compressed-dimensional representation of the forward channel state at the time k through a forward-prediction neural network (e.g., dynamicNet [symbol] ) to generate a compressed-dimensional predicted representation of the forward channel state at least one step forward in time k+Δ, wherein Δ is a number of steps forward in time. The number of step(s) forward in time, Δ, is also referred to by the term “m” herein. The operations further include sending 1106 the compressed-dimensional predicted representation of the forward channel state to one of the at least one network node, e.g., a BS.

Accordingly, in this embodiment it is assumed that the UE performs both the compression of the dimensional representation of the forward channel state and performs the mapping of the compressed-dimensional representation of the forward channel state at the time k through the forward-prediction neural network (e.g., dynamicNet [symbol] ) to generate the compressed-dimensional predicted representation of the forward channel state. The UE may operate to obtain 1100 the multi-dimensional representation of the forward channel state based on channel estimations of signals received from a single BS or from a plurality of BSs, and may then send 1106 the compressed-dimensional predicted representation of the forward channel state to the single BS or to any number of the plurality of BSs.

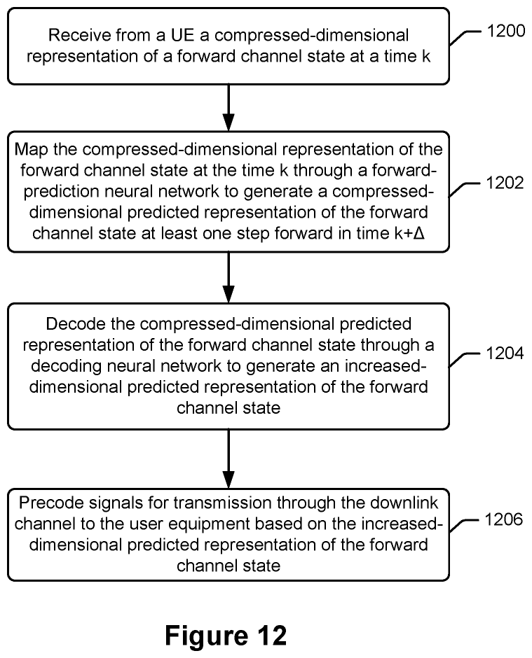

In some other embodiments, the network node, such as a BS, receives the compressed-dimensional representation of the forward channel state at the time k from the UE and is responsible for then mapping that representation of the forward channel state through the forward-prediction neural network (e.g., dynamicNet [symbol] ) to generate the compressed-dimensional predicted representation of the forward channel state. These operations are now generally described with regard to FIG. 12.

FIG. 12 illustrates a flowchart of operations that can be performed by a network node, such as a BS, for precoding of downlink communications predicting downlink channel state in accordance with some embodiments of the present disclosure. Referring to FIG. 12, the operations include receiving 1200, from a UE, a compressed-dimensional representation of a forward channel state at a time k generated from a multi-dimensional representation of the forward channel state at the time k encoded through an encoder neural network (e.g., first neural network model called encoder φ) of the user equipment, wherein the multi-dimensional representation is a higher dimensional representation than the compressed-dimensional representation. The operations include mapping 1202 the compressed-dimensional representation of the forward channel state at the time k through a forward-prediction neural network (e.g., dynamicNet [symbol] ) to generate a compressed-dimensional predicted representation of the forward channel state at least one step forward in time k+Δ, wherein Δ is a number of steps forward in time. The operations include decoding 1204 the compressed-dimensional predicted representation of the forward channel state through a decoding neural network (e.g., third neural network called decoder φ⁻¹) to generate an increased-dimensional predicted representation of the forward channel state at least one step forward in time k+Δ, wherein the increased-dimensional predicted representation is a higher dimensional representation than the compressed-dimensional predicted representation. The operations include precoding 1206 signals for transmission through the downlink channel to the UE based on the increased-dimensional predicted representation of the forward channel state.

In some embodiments, the decoding neural network (decoder (φ⁻¹)) is trained to approximate an inverse transformation of the encoder neural network (encoder (φ)).

In some embodiments, the encoder (φ), dynamicNet ( [symbol] ), and decoder (φ⁻¹) can be trained jointly, for instance, in order to minimize prediction loss in channel state,

$$arg {min}_{φ , ℱ , {φ}^{- 1}} ‖ {h}_{k + 1} - {φ}^{- 1} ( ℱ ( φ ( {h}_{k} ) ) ) ‖ .$$

In some embodiments, the encoder (φ), dynamicNet ( [symbol] ), and decoder (φ⁻¹) can be trained sequentially, for instance, step 1: encoder and decoder are first pre-trained in order to minimize reconstruction loss in channel state, and then step 2: the dynamicNet is trained to minimize prediction loss in channel state along with the pre-trained and frozen encoder and decoder (frozen means the parameters are not changed during training)

$$arg {min}_{φ , {φ}^{- 1}} ‖ {h}_{k} - {φ}^{- 1} ( φ ( {h}_{k} ) ) ‖ \qquad step 1$$

$$arg {min}_{ℱ} ‖ {h}_{k + 1} - {φ}^{- 1} ( ℱ ( φ ( {h}_{k} ) ) ) ‖ . \qquad step 2$$

In a generalized example of the above training, the network node, e.g., BS, is configured to pre-train parameters of the encoding neural network (encoder (φ) and decoding neural network (decoder (φ⁻¹)) based on a data feedback loop through the encoding neural network (encoder (φ)) and the decoding neural network (decoder (φ⁻¹)) to reduce error in the generation of the increased-dimensional representation of the forward channel state. The network node then trains parameters of the forward-prediction neural network (dynamicNet ( [symbol] )) based on another data feedback loop through the encoding neural network (encoder (φ)), the forward-prediction neural network (dynamicNet ( [symbol] )), and the decoding neural network (decoder (φ⁻¹)) to reduce error in the generation of the compressed-dimensional predicted representation of the forward channel state while parameters of the encoding neural network (encoder (φ)) and the decoding neural network (decoder (φ⁻¹)) are not trained (while the pre-trained parameters of the encoding neural network and the decoding neural network are fixed).

In some embodiments, the channel state is determined using channel estimation based on configured reference or pilot signals that are configured from the network to the UE to be present and available for measurements, in multiple OFDM symbols. For example, multiple symbols per slot or one or more symbols per slot and multiple slots (these multiple measurements are used in order to embed the temporal dynamic information in each channel state). The number of OFDM symbols may depend on wireless channel environments such as UE mobility.

Accordingly, in one embodiment, the UE can obtain the multi-dimensional representation of the forward channel state based on channel estimations of reference signals or pilot signals received from the at least one network node, e.g., BS, in time-frequency resource elements (REs) of a multiple-carrier slot-based channel.

In some embodiments, the channel state is determined using channel estimation based on reference or pilot signals from one or multiple subcarriers per Physical Resource Block (PRB), e.g. every n'th subcarrier, n=2, 4, 6, 12 (in order to embed the delay information in each channel state). The density (1/n) of number of subcarriers per PRB may be configured from the network to the UE for the multi-OFDM symbol measurement, and where the configuration is dependent on fading conditions.

In some embodiments, the channel states can be aggregated by the UE over multiple slots to enhance the dynamic temporal information in one channel state.

In some embodiments, the UE is configured by the network that channel states (i.e. individual measurements on reference signals (RS) in multiple slots) can be aggregated over these multiple slots. In one embodiment, the network signals to the UE that the RS in different OFDM symbols in a slot or across slots are quasi-co-located (QCL) with respect to one or more QCL Types, which enables the UE to perform said aggregation of multiple measurements. In another embodiment, the network signals to the UE that an antenna port of the RS in different OFDM symbols in a slot or across slots can be assumed to be the same antenna port, which enables the UE to perform said aggregation of multiple measurements, and in particular the UE can perform coherent aggregation.

In some embodiments, the dynamicNet ( [symbol] ) is performing one step-ahead prediction and can be applied to the received latent vector zₖ repeatedly m times, in order to make a multi-step-ahead latent prediction, zₖ₊ₘ= [symbol] ^{m}(zₖ) and where [symbol] can be jointly optimized with encoder and decoder as follows:

$$Where arg {min}_{φ , ℱ , {φ}^{- 1}} ‖ {h}_{k + m} - {φ}^{- 1} ( {ℱ}^{( m )} ( φ ( {h}_{k} ) ) ) ‖$$

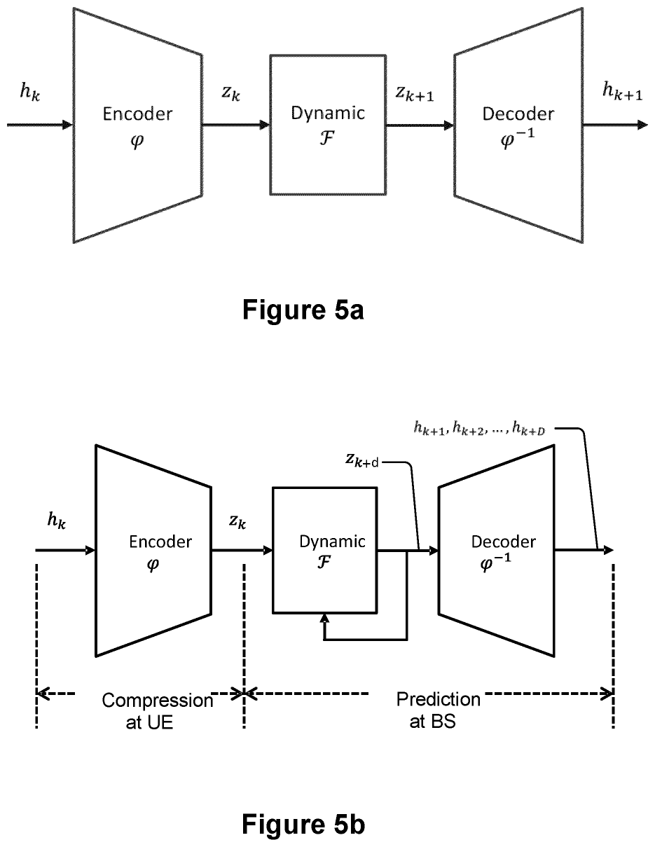

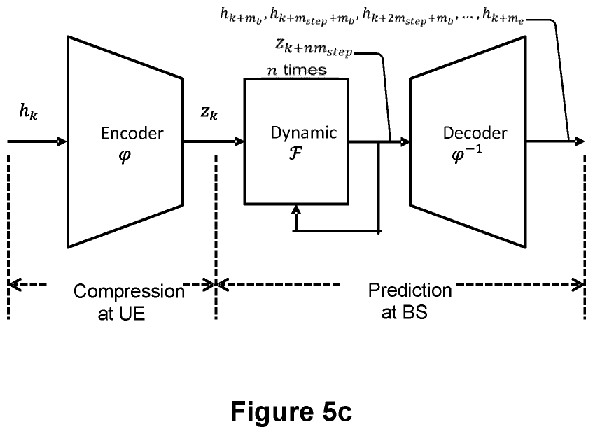

FIG. 5c shows the evoCSINet with three neural networks configured in accordance with some other embodiments to provide a multi-step-ahead prediction. In some embodiments, the predicted channels hₖ₊ₘ=φ⁻¹ ( [symbol] ^{(m)}(φ(hₖ)) at the BS are used in forward precoding design for transmission of e.g. the physical downlink shared channel (PDSCH) to the UE or jointly with CSI reporting from multiple UEs to perform a multi-user transmission of multiple PDSCHs. In one embodiment, the time density of channel state predictions is defined by the prediction time grid given by the first slot time (m_{b}), slot steps (mₛₜₑₚ) and the last slot time (mₑ), relative to the time k, to predict, [k+m_{b}:mₛₜₑₚ:k+mₑ]=>hₖ₊ₘ_{_{b}}, hₖ₊ₘ_{_{b}}₊ₘ_{ₛₜₑₚ}, hₖ₊ₘ_{_{b}}₊₂ₘ_{ₛₜₑₚ}, . . . , hₖ₊ₘ_{ₑ}. In one embodiment, for a slot which is not in the prediction time grid, the BS uses the channel state predictions in the nearest neighbor slots, e.g., hₖ₊ₘ=f(hₖ₊ₘp, hₖ₊ₘ_{_{b}}₊ₘ_{ₛₜₑₚ}), for m_{b}<m<m_{b}+mₖ_{ₛₜₑₚ}.

In one embodiment, the prediction states in the time grid [k+m_{b}:mₛₜₑₚ:k+mₑ] can be obtained by jointly optimizing the encoder, dynamicNet, and decoder according to the following constraints:

$$arg {min}_{φ , {φ}^{- 1}} ‖ {h}_{k + {m}_{b}} - {φ}^{- 1} ( φ ( {h}_{k} ) ) ‖ and arg {min}_{φ , ℱ , {φ}^{- 1}} ‖ φ ( {h}_{k + {m}_{step}} ) - ℱ ( φ ( {h}_{k} ) ) ‖$$

Numerous advantages may be provided by these and other embodiments disclosed herein. For example, unlike the AE-based CSI compression, which develops a compressed representation of channel data as shown in Equation (1) below, the evoCSINet-based CSI prediction learns a representation of low-dimensional latent dynamics of radio channel as shown in Equation (4) below. Moreover, as explained below, the evoCSINet yields a representation of channel dynamics from radio channel images that can use 3GPP CSI feedback mechanisms and achieves a single-step-ahead or multi-step-ahead predictions only based on the single latent feedback. As a result, the evoCSINet-based CSI prediction provides an accurate multi-step-ahead prediction model for dynamically changing radio channel under 3GPP CSI feedback mechanism.

Multi-step-ahead prediction problems are more challenging than single-step-ahead prediction. The effectiveness of the evoCSINet-based CSI prediction is discussed below through evaluations of channel predictions under 3GPP CSI feedback mechanism and further analysis of its impact on the performance of precoding design.

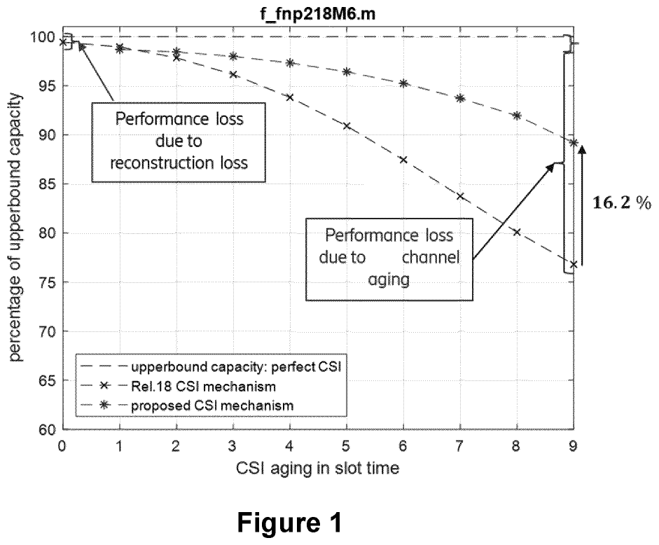

FIG. 1 illustrates a graph generated by simulations of percentage of upper-bound capacity as a function of CSI aging in slot time. FIG. 1 compares three different CSI cases including perfect CSI, aged CSI based on Release-18 AE-based CSI compression according to references “3GPP RP-213499” and “CSINet” identified above, and predicted CSI based on the evoCSINet-based CSI prediction. In the simulations, a 5G Urban Macro channel model was used and an outdoor UE moving at 15 km/h was assumed. The simulation evaluated 10% outage capacity performance under the three different CSI assumptions and normalized by the upper-bound capacity given by the perfect CSI in order to quantify prediction performance loss relative to the upper-bound. FIG. 1 shows the performance loss due to the channel aging is far more severe than the loss due to reconstruction error. In FIG. 1, the maximum ratio transmission (MRT) precoding with the aged CSI suffers about 24% performance loss due to channel aging with respect to the ideal case. FIG. 1 also shows that the evoCINet-based CSI prediction can reduce the performance loss by 54%, which corresponds to 89% of the maximum capacity with perfect CSI.

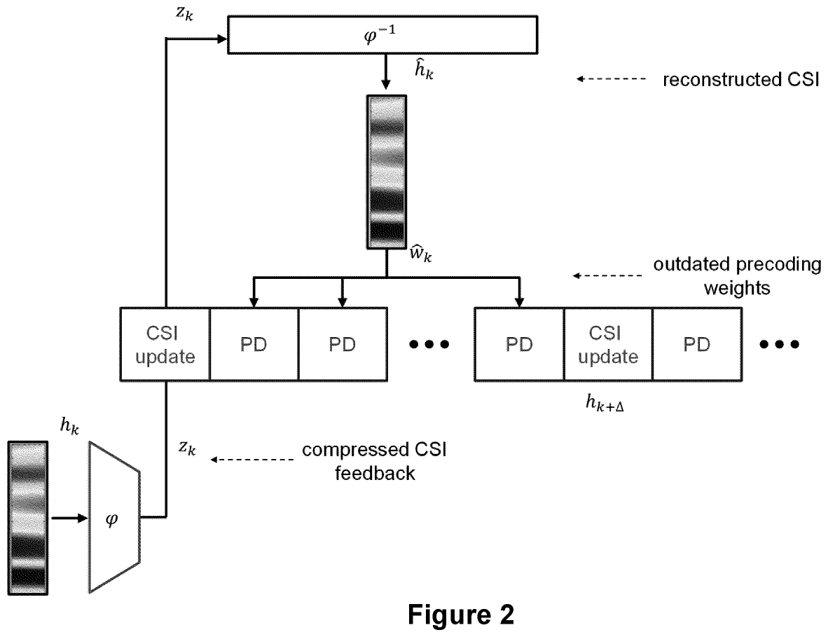

FIG. 2 illustrates a Release-18 CSI compression proposal based on autoencoder structure with encoder φ at the UE side and decoder φ⁻¹ at the base station (BS) side. The term PD is used as an abbreviation for precoded PDSCH.

FIG. 2 illustrates Release-18 CSI compression based on an autoencoder with encoder φ at the UE side and decoder φ⁻¹ at the BS side. The aim of AE-based CSI compression is to compress channel data at the UE side and to reconstruct the channel data with high accuracy based on the CSI feedback at the BS side. Note that the compression doesn't necessarily reduce the CSI report size compared to classical (i.e. Rel. 17 and earlier) solutions, but a compressed report can be seen as the useful information in the report is increased per signaled bit over the air interface from the UE to the BS.

Therefore, AE-based CSI compression should ideally satisfy the following condition

$${h}_{k} = {φ}^{- 1} ( φ ( {h}_{k} ) ) \qquad Equation ( 1 )$$

Dimension reduction occurs when high-dimensional states hₖ are encoded to a low dimensional approximation (or latent vector), zₖ=φ(hₖ), which enables operations to minimize the signal overhead from UE to BS or to increase the conveyed useful information to the BS. Note that the classical method also use a kind of compression φ(hₖ) by using a codebook of channels to represent the channel hₖ with a limited set of bits (typically 10-600 bits depending on codebook configuration).

However, as can be seen in FIG. 1, the CSI becomes outdated due to the channel variation over time, which results in severe performance degradation because the performance of precoding design based on the outdated CSI is limited by channel aging. Moreover, it is not possible to predict the temporal evolution of radio channel under the existing AE-based CSI feedback mechanism because the AE is an artificial neural network that learns a latent representation of channel data, which does not contain any dynamical information.

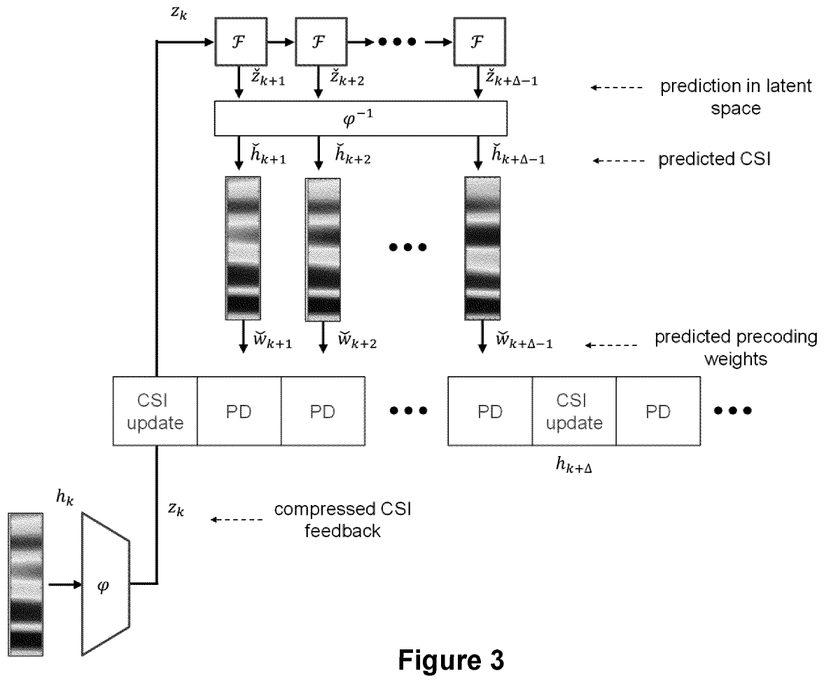

FIG. 3 illustrates CSI prediction based on evoCSINet with an encoder neural network φ in the UE, and with a dynamics process neural network [symbol] (also referred to as a forward-prediction neural network) and decoder neural network φ⁻¹ in the BS or other network node, in accordance with some embodiments of the present disclosure. The term PD is again used as an abbreviation for precoded PDSCH.

Referring to FIG. 3, in order to minimize the channel aging effect on precoding performance, an ML-driven solution is used that allows accurate predictions of time-varying channel variation over time using 3GPP CSI feedback mechanisms. The network configures the UE with reference signals to be used for CSI reporting, such as CSI-reference signal (CSI-RS). The network also configures the UE with a CSI report of a certain type that enables the use of channel prediction and/or the use of machine learning modules to generate at least parts of the CSI report.

In a corresponding embodiment, the UE can be configured to train parameters of the forward-prediction neural network (e.g., dynamics process neural network [symbol] ) to model time-variation in the forward channel state for a 3GPP CSI feedback mechanism from the user equipment to the one of the at least one network node, e.g., BS.

The UE measures the channel using these configured reference signals, generates the CSI report, and transmits the report to the network. The network subsequently uses information in the report to compute a precoding vector or matrix for transmission of the data channel (PDSCH) and/or control channel (Physical Downlink Control Channel (PDCCH)) to the UE. Accordingly, in some embodiments, the operation by the network node for precoding 1206 (FIG. 12) of signals for transmission through the downlink channel to the UE based on the increased-dimensional predicted representation of the forward channel state, includes computing a precoding vector or matrix for transmission of a data channel and/or a control channel to the UE.

Prior to the network configuring such CSI report to the UE, the network may have requested capability information from the UE to assess whether the UE is capable (operationally configured) of supporting the considered CSI report type. This capability information may be conveyed to the network using the physical uplink shared data channel (PUSCH). In some embodiments, the network does not expect (does not assume) the UE to be configured with the new report type unless it has been configured with the appropriate reference signal (RS) to perform the task.

The RS that is configured to the UE for the measurements may be accompanied with control information that allows the UE to aggregate measurements on RS from multiple OFDM symbols, even in different slots.

In one embodiment, the network signals to the UE that the RS in different OFDM symbols in a slot or across slots are quasi-co-located (QCL) with respect to one or more QCL Types, which enables the UE to perform said aggregation of multiple measurements.

In another embodiment, the network signals to the UE that an antenna port of the RS in different OFDM symbols in a slot or across slots can be assumed to be the same antenna port, which enables the UE to perform said aggregation of multiple measurements, and in particular the UE can perform coherent aggregation.

In another embodiment, the network signals to the UE that measurement restriction of the RS is not enabled, (alternatively refrain from signalling that it is enabled) which means that the UE is allowed to use multiple measurements in generating a CSI report.

For the channel evolution a model may use a discrete-time dynamical system such as provided in Equation 2.

$${h}_{k + 1} = f ( {h}_{k} ) \qquad Equation ( 2 )$$

In Equation 2, f represents a dynamics that maps the state hₖ one step forward in discrete time. The temporal dynamics of radio channel is generally nonlinear and often unknown.

Unlike the existing AE-based CSI compression method, which finds a compressed representation of channel data (as measured on the RS as explained above), the evoCSINet framework learns a low-dimensional representation of channel dynamics in Equation (2) for prediction applications.

Compared to the AE-based CSI compression shown in FIG. 2, FIG. 3 shows the evoCSINet-based CSI prediction with encoder neural network φ at the UE side, and dynamics [symbol] (forward-prediction neural network) and decoder neural network φ⁻¹ at the BS side or other network node side.

The evoCSINet may be divided into three submodels: encoder neural network φ, latent dynamics [symbol] (forward-prediction neural network), and decoder neural network φ⁻¹, where, for brevity, the same notation for the encoder and decoder may be used for evoCSINet as that of AE in FIG. 2, but its functional roles and actual trained models are different from each other. The encoder φ can be considered as a data transformation, zₖ=φ(hₖ), onto a low-dimensional manifold, on which the latent dynamics is given by [symbol] , that is,

$${z}_{k + 1} = ℱ ( {z}_{k} ) \qquad Equation ( 3 )$$

In Equation (3), [symbol] may represent the same dynamical system as f in Equation (2), but in a latent space.

Furthermore, the latent vector zₖ₊₁ may be converted to the original state by the decoder φ⁻¹, doing the inverse of encoder φ. Combining these three submodels, the evoCSINet according to some embodiments of the present disclosure can approximate the state dynamics by

$${φ}^{- 1} ( ℱ ( φ ( {h}_{k} ) ) ) = {φ}^{- 1} ( ℱ ( {z}_{k} ) ) = {φ}^{- 1} ( {z}_{k + 1} ) = {h}_{k + 1} \qquad Equation ( 4 )$$

As a case study, a multi-step-ahead prediction problem is considered with the prediction depth D, where the BS acquires the compressed CSI feedback zₖ of downlink channel state hₖ and estimates the next D channel states hₖ, hₖ₊₁, . . . , h_{k+D} into the future. As can be seen in FIG. 3, the prediction depth D is inherently coupled by the CSI feedback interval in the 3GPP specifications. In one illustrative embodiment, the prediction depth is set as D=9, which means that the BS predicts channel states based on CSI feedback from the UE at a 10-slot interval.

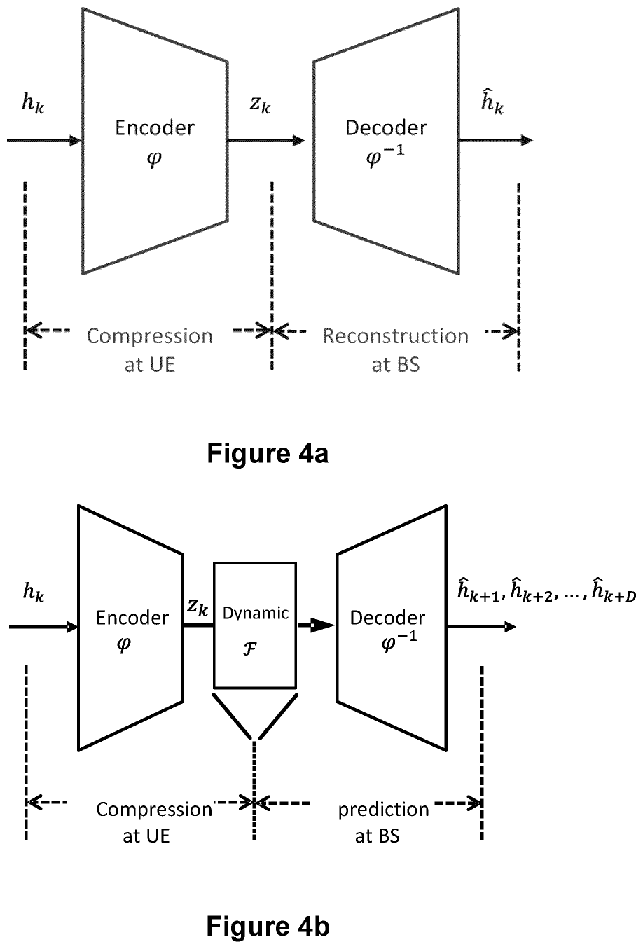

FIG. 4a illustrates a schematic diagram of one approach for AE-based CSI compression. FIG. 4b illustrates a schematic diagram of a evoCSINet-based CSI prediction according to some embodiments of the present disclosure.

FIG. 4a shows how the approach for AE operates as a compression and reconstruction model for the CSI compression shown in FIG. 2. The encoder maps the channel data hₖ to the latent vector zₖ, zₖ=φ(hₖ), at the UE side. The decoder is applied at the BS side to reconstruct the original channel data hₖ=φ⁻¹(zₖ) from the feedback zₖ.

In contrast, FIG. 4b illustrates how the evoCSINet approach of some present embodiments operates as a multi-step-ahead prediction model for the CSI prediction shown in FIG. 3. In contrast to FIG. 4a, the evoCSINet approach shown in FIG. 4b includes a forward-prediction neural network (also called dynamicNet [symbol] ) which is configured to produce a single-step-ahead or multi-step-ahead prediction in the space of channel state based on the single latent feedback zₖ. The forward-prediction neural network (dynamicNet [symbol] ) can be implemented on the UE side or the BS side. This can mean that the evoCSINet may work with the same amount of feedback as that of a conventional AE-based approach.

In some embodiments, the multi-step-ahead prediction can be performed by the UE through recursive feedback or daisy-chaining of predicted forward channel state through the forward-prediction neural network to predict further steps ahead in time. The term daisy-chaining can refer to providing the output of first step-ahead prediction operational stage to the input of a second step-ahead prediction operational stage, and providing the output of the second step-ahead prediction operational stage to the input of a third step-ahead prediction operational stage, and so-on for N step-ahead prediction operational stages where N is a plural number. In the context of the embodiment of FIG. 11, the mapping 1104 of the compressed-dimensional representation of the forward channel state at the time k through the forward-prediction neural network to generate the compressed-dimensional predicted representation of the forward channel state at least one step forward in time k+Δ, includes to repeating for each step-ahead prediction Δ time, an operation to feed output by the forward-prediction neural network from the previous step, the compressed-dimensional predicted representation of the forward channel state for one step forward in time, as an input to the forward-prediction neural network to generate a compressed-dimensional predicted representation of the forward channel state for a next step forward in time.

In another embodiment, the forward-prediction neural network includes a plurality of daisy changed stages. The operation of FIG. 11 to generate the compressed-dimensional predicted representation of the forward channel state at least one step forward in time k+Δ, includes each step-ahead prediction Δ time, an operation to feed output by a previous stage of the forward-prediction neural network as an input to a next stage of the forward-prediction neural network to generate a compressed-dimensional predicted representation of the forward channel state for a next step forward in time.

In some embodiments, the multi-step-ahead prediction can be performed by the network node, e.g., BS, through recursive feedback or daisy-chaining of predicted forward channel state through the forward-prediction neural network network (second neural network called dynamicNet [symbol] ) to predict further steps ahead in time. In the context of the embodiment of FIG. 12, the mapping 1202 of the compressed-dimensional representation of the forward channel state at the time k through the forward-prediction neural network to generate the compressed-dimensional predicted representation of the forward channel state at least one step forward in time k+Δ, includes repeating for each step-ahead prediction Δ time, an operation to feed output by the forward-prediction neural network from the previous step, the compressed-dimensional predicted representation of the forward channel state for step forward in time as an input to the forward-prediction neural network to generate a compressed-dimensional predicted representation of the forward channel state for a next step forward in time.

In another embodiment, the forward-prediction neural network includes a plurality of daisy changed stages. The operation of FIG. 12 for mapping 1202 of the compressed-dimensional representation of the forward channel state at the time k through the forward-prediction neural network to generate the compressed-dimensional predicted representation of the forward channel state at least one step forward in time k+Δ, includes for each step-ahead prediction Δ time, an operation to feed output by a previous stage of the forward-prediction neural network as an input to a next stage of the forward-prediction neural network to generate a compressed-dimensional predicted representation of the forward channel state for a next step forward in time.

FIG. 5a shows a basic architecture of the evoCSINet with three neural networks configured in accordance with some embodiments. The encoder neural network φ transforms state space to latent space, zₖ=φ(hₖ), the dynamicsNet neural network [symbol] maps the latent vector zₖ one step forward in time, zₖ₊₁= [symbol] (zₖ), and the decoder neural network φ⁻¹ reconstructs the state from the latent prediction, hₖ₊₁=φ⁻¹(zₖ₊₁).

This factorized representation of state dynamics is especially advantageous for prediction problems under CSI feedback mechanism since the decomposition of φ, [symbol] , and φ⁻¹ submodels allows evoCSINet to fit into the CSI feedback procedure shown in FIG. 3 and achieve the multi-step-ahead predictions only based on the single latent feedback zₖ.

In comparison, FIG. 5b shows the evoCSINet with three neural networks configured in accordance with some other embodiments to provide a multi-step-ahead prediction. As shown in FIG. 5b, a multi-step channel prediction can be achieved in latent space by applying the dynamicsNet neural network [symbol] to the output of an encoder neural network in a recursive manner until the depth D. In other words, at an initial time step k, a latent vector is generated by the encoder neural network as zₖ=q (hₖ). The next D latent predictions can be produced recursively by applying neural network [symbol] to the latent vectors until the final latent prediction z_{k+D}. Finally, the decoder neural network can produce the multi-step predictions hₖ₊₁=φ⁻¹(zₖ₊₁), . . . , h_{k+D}=φ⁻¹(z_{k+D}) based on the latent predictions zₖ₊₁, . . . , z_{k+D}.

Therefore, the single-step prediction in Equation (4) can be extended for the multi-step-ahead prediction

$${h}_{k + m} = {φ}^{- 1} ( {ℱ}^{( m )} ( φ ( {h}_{k} ) ) ) \qquad Equation ( 5 )$$

where [symbol] ^{(m)}(φ(hₖ)) denotes m applications of F to the initial latent vector zₖ=φ(hₖ), resulting to zₖ₊ₘ.

Deep learning can be applied on state measurements to approximate three sub-models for encoder neural network φ, dynamics process neural network [symbol] and decoder neural network φ⁻¹ of the target evoCSINet framework that satisfies the condition in Equation (4).

The training requires a data set of state episodes given by time series h₁, h₂, . . . , h_{L} where L is the length of each episode. The loss function has three loss terms; reconstruction loss [symbol] _{rec}, state prediction loss [symbol] _{pred,h}, and latent prediction loss [symbol] _{pred,z}.

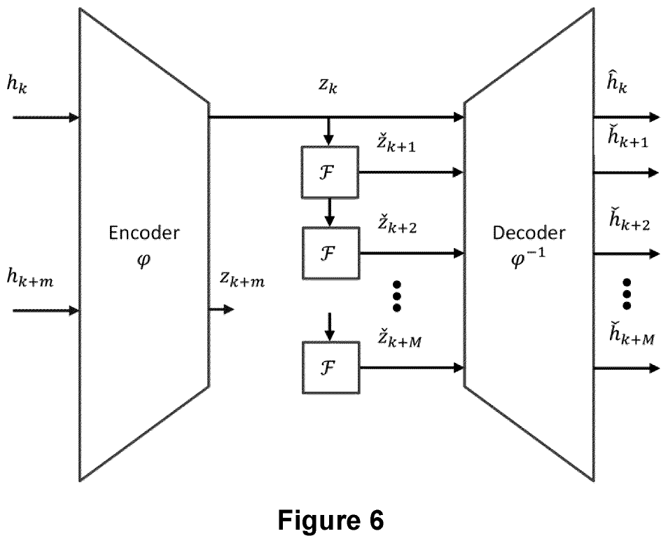

FIG. 6 illustrates a block diagram of the encoder neural network φ, dynamics process neural network [symbol] , and decoder neural network φ⁻¹ being trained using examples of data samples, in accordance with some embodiments.

The term [symbol] _{rec} is defined with the encoder φ and decoder φ⁻¹ over a pair of true channel state hₖ and its reconstruction ĥₖ at time k, as follows:

$${ℒ}_{rec} = \frac{1}{M + 1} {\sum }_{m = 0}^{M + 1} ‖ {h}_{k + m} - {\hat{h}}_{k + m} ‖$$

where the norm ∥⋅∥ is defined by mean absolute error (MAE) on all the pixels between matrices or vectors.

Next, we define two prediction loss terms [symbol] _{pred,h} and [symbol] _{pred,z} as

$${ℒ}_{pred , h} = \frac{1}{M} {\sum }_{m = 1}^{M} ‖ {h}_{k + m} - {φ}^{- 1} ( {ℱ}^{( m )} ( φ ( {h}_{k} ) ) ) ‖$$

$$and$$

$${ℒ}_{pred , z} = \frac{1}{M} {\sum }_{m = 1}^{M} ‖ φ ( {h}_{k + m} ) - {ℱ}^{( m )} ( φ ( {h}_{k} ) ) ‖$$

where M is the size of prediction window in time horizons.

To update the neural network submodels φ, [symbol] and φ⁻¹ in training process, the following weighted loss function of three loss terms can be used

$${ℒ}_{sum} = {ℒ}_{pred , h} + {αℒ}_{rec} + {βℒ}_{pred , z}$$

where α determines a compromise between prediction accuracy and reconstruction accuracy and β achieves a best trade-off between state and latent prediction accuracy.

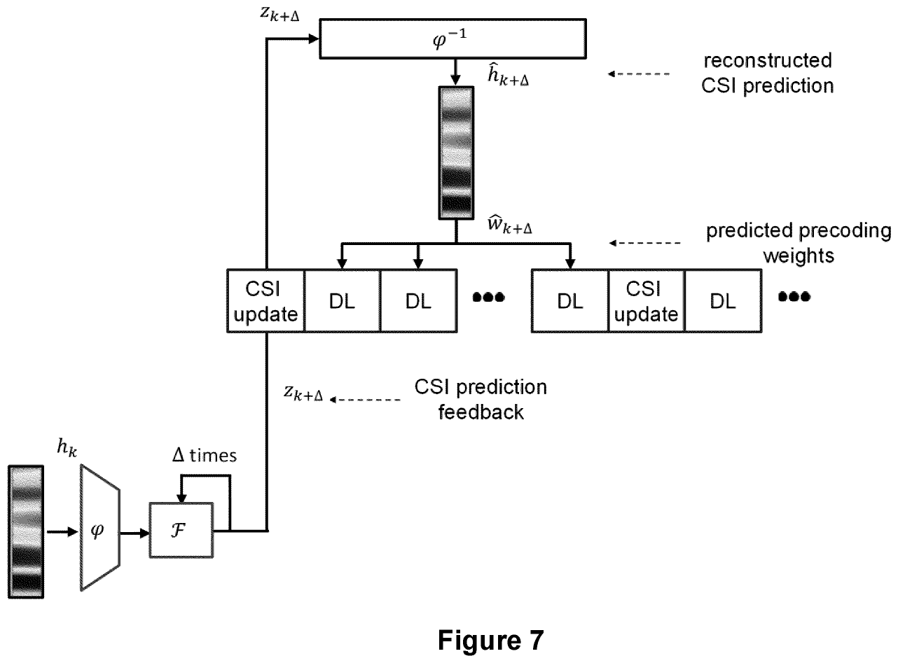

FIG. 7 illustrates a block diagram of the CSI prediction system in which the encoder neural network φ and the dynamics process neural network [symbol] are located in the UE and the decoder neural network φ⁻¹ is located in the BS, or other network node, and configured for CSI prediction in accordance with some embodiments.

For the system of FIG. 7, the operations include reporting to the network node, e.g., BS, that the reported CSI value is a predicted value, Δ steps ahead in time where steps may be represented in milliseconds or slots, etc. Accordingly, the UE reports the dynamics output together with the value Δ. This reporting can be in the same uplink control information massage or it can be in a Medium Access Control Control Element (MAC CE) message. For this case, the UE can assess the robustness of the prediction and decide on a suitable Δ value to use of the CSI report. The network node can need to know Δ in order to correctly use the CSI report from the UE.

Alternatively, the value Δ is RRC configured from the network node to the UE and is thus a fixed value.

In addition, the UE can operate to report in a UE capability signaling that it supports prediction (Δ>0) possible also in conjunction with a maximum prediction horizon. For example, the UE may report the largest Δ it can use. Alternatively, the UE may report a capability that it supports prediction (Δ) but the value to use may be determined (selected) by the UE. For this case, there may also be a configuration message from the network node to the UE indicating whether the UE may use the prediction or whether the UE should always use no prediction (Δ=0). There may be reasons why the network node doesn't want the UE to perform the prediction, e.g., because prediction may cause the reported CSI to be less reliable.

Accordingly, some embodiments are directed to various operations that can be performed by a UE to notify the network node, e.g., BS, if generation of future CSI predictions is supported. In one embodiment, the UE sends to the one of the at least one network node an indication that the user equipment supports generation of predicted representations of the forward channel state. The sending to the one of the at least one network node of the indication that the user equipment supports generation of predicted representations of the forward channel state, may include indicating how many steps m forward in time of prediction are supported. In another embodiment, the UE configures how many steps m forward in time of prediction the UE performs based on control information configuring channel state information (CSI) reporting by the UE. In another embodiment, the indication that the UE supports generation of predicted representations of the forward channel state, is sent through an uplink shared data channel, uplink control information message, or MAC CE message.

In some corresponding embodiments, the network node, e.g., BS, determines from capability information received from the UE that the UE supports prediction of the forward channel state. The determination from the capability information received from the UE that the UE supports prediction of the forward channel state, may include determining how many steps m forward in time of prediction are supported by the UE. The network node may receive the capability information from the UE through an uplink shared data channel, uplink control information message, or Medium Access Control Control Element message. The network node may configure CSI reporting by the UE based on the UE determined to support prediction of the forward channel state. The operation by the network node to configure CSI reporting by the UE based on the UE determined to support prediction of the forward channel state, may include configuring how many steps m forward in time the UE provides reporting for prediction of the forward channel state. The operation by the network node to configure CSI reporting by the UE based on the UE determined to support prediction of the forward channel state, may include sending control information configured to control the UE to aggregate measurements on reference signals, RS, from a plurality of orthogonal frequency-division multiplexing, OFDM, symbols in one or more slots.

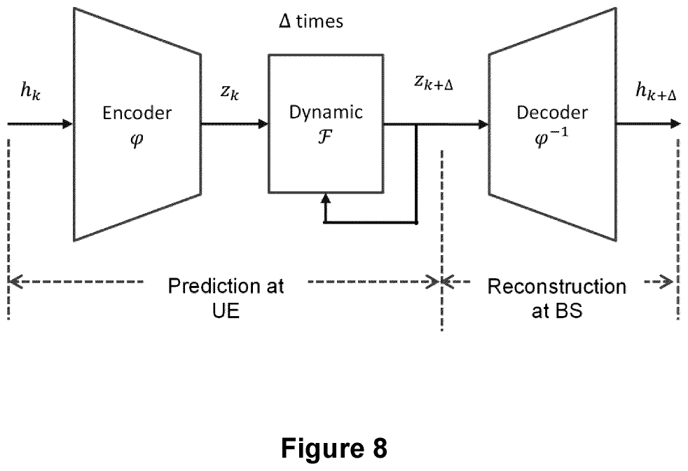

FIG. 8 illustrates another block diagram of the CSI prediction system in which the encoder neural network φ and the dynamics process neural network [symbol] are located in the UE and the decoder neural network φ⁻¹ is located in the BS, or other network node, and configured for multi-step ahead channel prediction in accordance with some embodiments.

Referring to FIG. 8, a multi-step channel prediction is provided in latent space by applying the dynamics process neural network [symbol] to the output of the encoder neural network in a recursive manner until the target depth Δ at the UE side, resulting in z_{k+Δ}. The decoder neural network can produce the multi-step predictions h_{k+Δ}=φ⁻¹ (z_{k+Δ}) based on the latent feedback z_{k+Δ} at the BS side.

The value of parameter Δ can be associated with UE prediction capability of how far the UE can predict channel into the future or the total latency between the CSI acquisition at UE and its application at BS. Accordingly, and explained above, the parameter Δ can be configured between the UE and the BS.

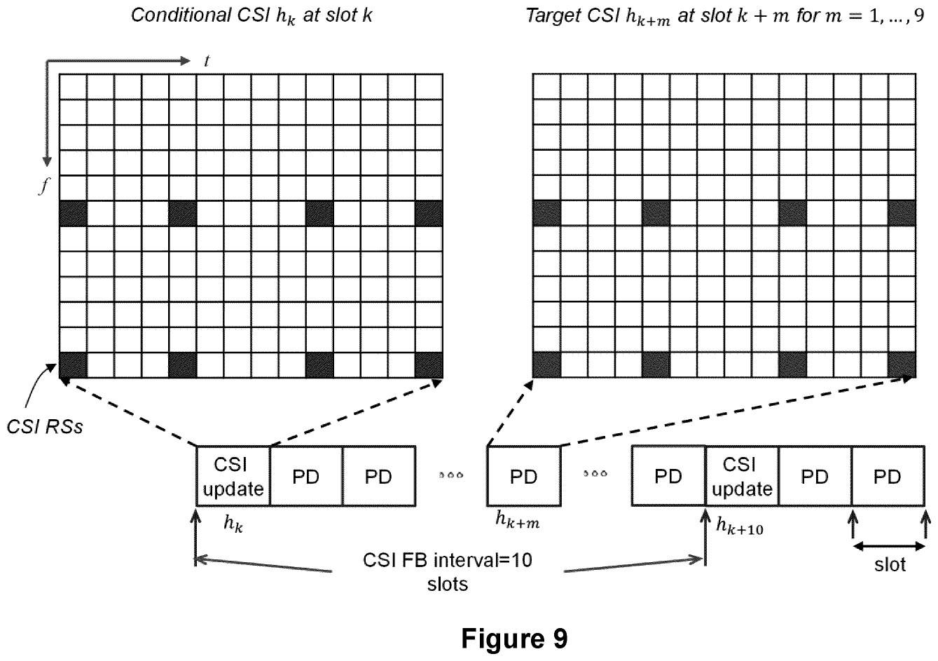

FIG. 9 illustrates CSI RS configurations in single-slot mode in which the conditional input channel hₖ is generated by channel responses of conditional CSI-RSs from a single slot and the target output channels hₖ₊ₘ for m=1, 2, . . . , 9, to be predicted in a recursive manner are given by channel responses of target CSI RSs from future slots, in accordance with some embodiments. Note that the channel is predicted for the same resource elements as the measured CSI-RS, in this embodiment. After this prediction, the UE may further interpolate the channel to obtain the channel at every resource element (in between). It is noted that the number of steps forward in time, Δ or m, may be a time unit that corresponds to, for example, a subframe or slot, e.g., having 14 OFDM symbols for conditional input channel state and forward-channel prediction. The conditional input state can be defined by channel states of CSI-RS REs of four OFDM symbols within a given time unit. Channel states of CSI-RS REs of four OFDM symbols in future time steps can be predicted with a comb-factor 6 in frequency domain. For example, there can be 9 time steps to predict between two consecutive CSI updates with 10-slot interval.

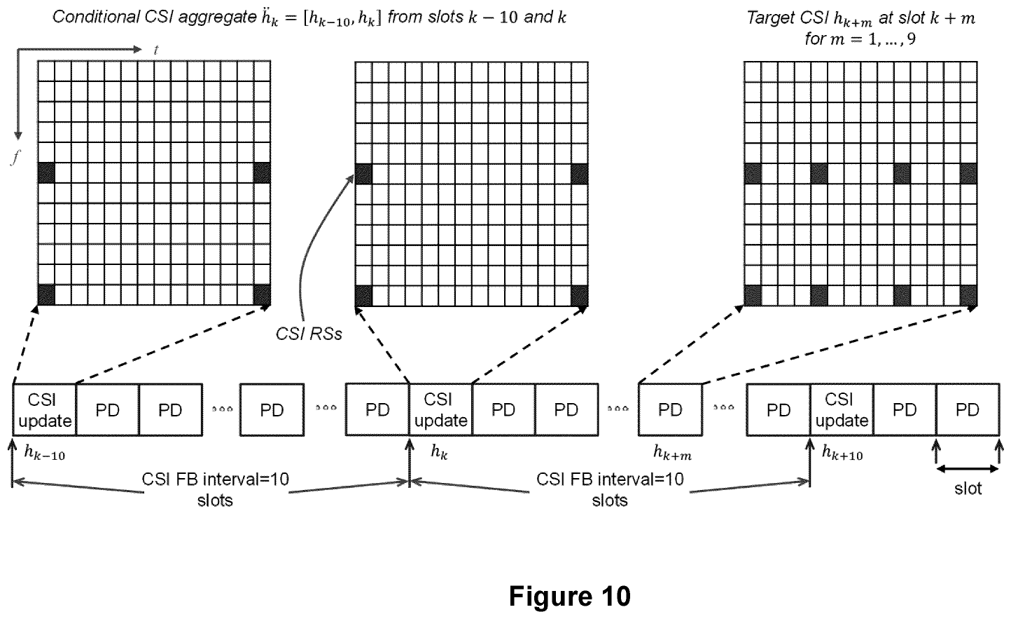

FIG. 10 illustrates CSI RS configurations in dual-slot mode (or aggregate mode) in which the conditional input channel \ddot{h}ₖ=[hₖ₋₁₀, hₖ] is generated by channel responses of conditional CSI-RSs from two slots and the target output channels hₖ₊ₘ for m=1, 2, . . . , 9, to be predicted in a recursive manner are given by channel responses of target CSI RSs from future slots, in accordance with some embodiments. Here, the time unit can be a subframe group of two subframes for conditional input channel state. The conditional input channel state can be defined by channel states of CSI-RS REs of four OFDM symbols within a given time unit, including two OFDM symbols from each subframe. The time unit can be one subframe for forward-channel prediction. Channel states of CSI-RS REs of four OFDM symbols in future time steps are predicted with a comb-factor 6 in frequency domain. For example, in FIG. 10 there can be 9 time steps to predict between two consecutive CSI updates with 10-slot interval.

### ADDITIONAL EMBODIMENTS

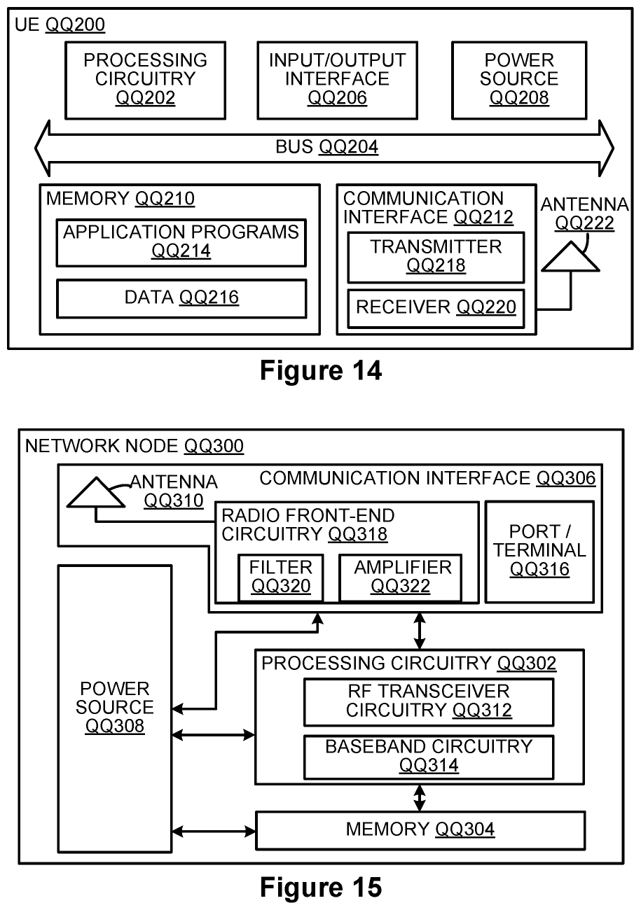

Operations of the communication device QQ200 (implemented using the structure of the block diagram of FIG. 14) will now be discussed with reference to the flow charts of FIG. 11 according to some embodiments of inventive concepts. For example, modules may be stored in memory QQ210 of FIG. 14, and these modules may provide instructions so that when the instructions of a module are executed by respective communication device processing circuitry QQ202, processing circuitry QQ202 performs respective operations of the flow chart.

Various operations from the flow chart of FIG. 11 may be optional with respect to some embodiments of communication devices and related methods.

Operations of the RAN node QQ300 (implemented using the structure of FIG. 15) will now be discussed with reference to the flow chart of FIG. 12 according to some embodiments of inventive concepts. For example, modules may be stored in memory QQ304 of FIG. 15, and these modules may provide instructions so that when the instructions of a module are executed by respective RAN node processing circuitry QQ220, RAN node QQ300 performs respective operations of the flow chart.

Various operations from the flow chart of FIG. 12 may be optional with respect to some embodiments of RAN nodes and related methods.

Operations of the Core Network CN node QQ300 (implemented using the structure of FIG. 15) will now be discussed with reference to the flow chart of FIG. 12 according to some embodiments of inventive concepts. For example, modules may be stored in memory QQ304 of FIG. 15, and these modules may provide instructions so that when the instructions of a module are executed by respective CN node processing circuitry QQ302, CN node QQ300 performs respective operations of the flow chart.

Various operations from the flow chart of FIG. 12 may be optional with respect to some embodiments of CN nodes and related methods.

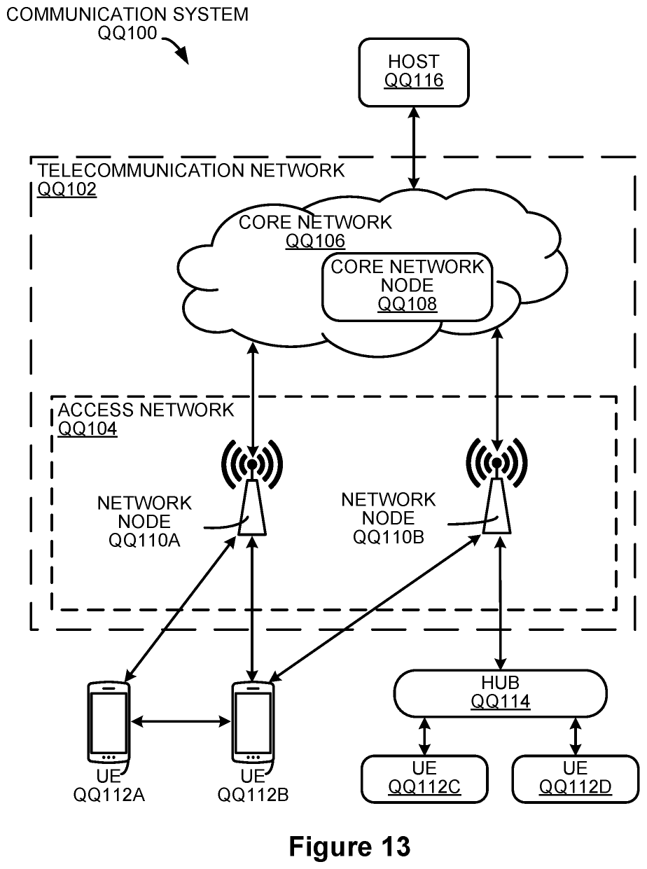

FIG. 13 shows an example of a communication system QQ100 in accordance with some embodiments.

In the example, the communication system QQ100 includes a telecommunication network QQ102 that includes an access network QQ104, such as a radio access network (RAN), and a core network QQ106, which includes one or more core network nodes QQ108. The access network QQ104 includes one or more access network nodes, such as network nodes QQ110a and QQ110b (one or more of which may be generally referred to as network nodes QQ110), or any other similar 3rd Generation Partnership Project (3GPP) access node or non-3GPP access point. The network nodes QQ110 facilitate direct or indirect connection of user equipment (UE), such as by connecting UEs QQ112a, QQ112b, QQ112c, and QQ112d (one or more of which may be generally referred to as UEs QQ112) to the core network QQ106 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system QQ100 may include any number of wired or wireless networks, network nodes, UEs, and/or any other components or systems that may facilitate or participate in the communication of data and/or signals whether via wired or wireless connections. The communication system QQ100 may include and/or interface with any type of communication, telecommunication, data, cellular, radio network, and/or other similar type of system.

The UEs QQ112 may be any of a wide variety of communication devices, including wireless devices arranged, configured, and/or operable to communicate wirelessly with the network nodes QQ110 and other communication devices. Similarly, the network nodes QQ110 are arranged, capable, configured, and/or operable to communicate directly or indirectly with the UEs QQ112 and/or with other network nodes or equipment in the telecommunication network QQ102 to enable and/or provide network access, such as wireless network access, and/or to perform other functions, such as administration in the telecommunication network QQ102.

In the depicted example, the core network QQ106 connects the network nodes QQ110 to one or more hosts, such as host QQ116. These connections may be direct or indirect via one or more intermediary networks or devices. In other examples, network nodes may be directly coupled to hosts. The core network QQ106 includes one more core network nodes (e.g., core network node QQ108) that are structured with hardware and software components. Features of these components may be substantially similar to those described with respect to the UEs, network nodes, and/or hosts, such that the descriptions thereof are generally applicable to the corresponding components of the core network node QQ108. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host QQ116 may be under the ownership or control of a service provider other than an operator or provider of the access network QQ104 and/or the telecommunication network QQ102, and may be operated by the service provider or on behalf of the service provider. The host QQ116 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system QQ100 of FIG. 13 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network QQ102 is a cellular network that implements 3GPP standardized features. Accordingly, the telecommunications network QQ102 may support network slicing to provide different logical networks to different devices that are connected to the telecommunication network QQ102. For example, the telecommunications network QQ102 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs QQ112 are configured to transmit and/or receive information without direct human interaction. For instance, a UE may be designed to transmit information to the access network QQ104 on a predetermined schedule, when triggered by an internal or external event, or in response to requests from the access network QQ104. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub QQ114 communicates with the access network QQ104 to facilitate indirect communication between one or more UEs (e.g., UE QQ112c and/or QQ112d) and network nodes (e.g., network node QQ110b). In some examples, the hub QQ114 may be a controller, router, content source and analytics, or any of the other communication devices described herein regarding UEs. For example, the hub QQ114 may be a broadband router enabling access to the core network QQ106 for the UEs. As another example, the hub QQ114 may be a controller that sends commands or instructions to one or more actuators in the UEs. Commands or instructions may be received from the UEs, network nodes QQ110, or by executable code, script, process, or other instructions in the hub QQ114. As another example, the hub QQ114 may be a data collector that acts as temporary storage for UE data and, in some embodiments, may perform analysis or other processing of the data. As another example, the hub QQ114 may be a content source. For example, for a UE that is a VR headset, display, loudspeaker or other media delivery device, the hub QQ114 may retrieve VR assets, video, audio, or other media or data related to sensory information via a network node, which the hub QQ114 then provides to the UE either directly, after performing local processing, and/or after adding additional local content. In still another example, the hub QQ114 acts as a proxy server or orchestrator for the UEs, in particular if one or more of the UEs are low energy IoT devices.

The hub QQ114 may have a constant/persistent or intermittent connection to the network node QQ110b. The hub QQ114 may also allow for a different communication scheme and/or schedule between the hub QQ114 and UEs (e.g., UE QQ112c and/or QQ112d), and between the hub QQ114 and the core network QQ106. In other examples, the hub QQ114 is connected to the core network QQ106 and/or one or more UEs via a wired connection. Moreover, the hub QQ114 may be configured to connect to an M2M service provider over the access network QQ104 and/or to another UE over a direct connection. In some scenarios, UEs may establish a wireless connection with the network nodes QQ110 while still connected via the hub QQ114 via a wired or wireless connection. In some embodiments, the hub QQ114 may be a dedicated hub—that is, a hub whose primary function is to route communications to/from the UEs from/to the network node QQ110b. In other embodiments, the hub QQ114 may be a non-dedicated hub—that is, a device which is capable of operating to route communications between the UEs and network node QQ110b, but which is additionally capable of operating as a communication start and/or end point for certain data channels.

FIG. 14 shows a UE QQ200 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE QQ200 includes processing circuitry QQ202 that is operatively coupled via a bus QQ204 to an input/output interface QQ206, a power source QQ208, a memory QQ210, a communication interface QQ212, and/or any other component, or any combination thereof. Certain UEs may utilize all or a subset of the components shown in Figure QQ2. The level of integration between the components may vary from one UE to another UE. Further, certain UEs may contain multiple instances of a component, such as multiple processors, memories, transceivers, transmitters, receivers, etc.

The processing circuitry QQ202 is configured to process instructions and data and may be configured to implement any sequential state machine operative to execute instructions stored as machine-readable computer programs in the memory QQ210. The processing circuitry QQ202 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry QQ202 may include multiple central processing units (CPUs).

In the example, the input/output interface QQ206 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE QQ200. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source QQ208 is structured as a battery or battery pack. Other types of power sources, such as an external power source (e.g., an electricity outlet), photovoltaic device, or power cell, may be used. The power source QQ208 may further include power circuitry for delivering power from the power source QQ208 itself, and/or an external power source, to the various parts of the UE QQ200 via input circuitry or an interface such as an electrical power cable. Delivering power may be, for example, for charging of the power source QQ208. Power circuitry may perform any formatting, converting, or other modification to the power from the power source QQ208 to make the power suitable for the respective components of the UE QQ200 to which power is supplied.

The memory QQ210 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory QQ210 includes one or more application programs QQ214, such as an operating system, web browser application, a widget, gadget engine, or other application, and corresponding data QQ216. The memory QQ210 may store, for use by the UE QQ200, any of a variety of various operating systems or combinations of operating systems.

The memory QQ210 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory QQ210 may allow the UE QQ200 to access instructions, application programs and the like, stored on transitory or non-transitory memory media, to off-load data, or to upload data. An article of manufacture, such as one utilizing a communication system may be tangibly embodied as or in the memory QQ210, which may be or comprise a device-readable storage medium.

The processing circuitry QQ202 may be configured to communicate with an access network or other network using the communication interface QQ212. The communication interface QQ212 may comprise one or more communication subsystems and may include or be communicatively coupled to an antenna QQ222. The communication interface QQ212 may include one or more transceivers used to communicate, such as by communicating with one or more remote transceivers of another device capable of wireless communication (e.g., another UE or a network node in an access network). Each transceiver may include a transmitter QQ218 and/or a receiver QQ220 appropriate to provide network communications (e.g., optical, electrical, frequency allocations, and so forth). Moreover, the transmitter QQ218 and receiver QQ220 may be coupled to one or more antennas (e.g., antenna QQ222) and may share circuit components, software or firmware, or alternatively be implemented separately.

In the illustrated embodiment, communication functions of the communication interface QQ212 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface QQ212, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE QQ200 shown in FIG. 14.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 15 shows a network node QQ300 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node QQ300 includes a processing circuitry QQ302, a memory QQ304, a communication interface QQ306, and a power source QQ308. The network node QQ300 may be composed of multiple physically separate components (e.g., a NodeB component and a RNC component, or a BTS component and a BSC component, etc.), which may each have their own respective components. In certain scenarios in which the network node QQ300 comprises multiple separate components (e.g., BTS and BSC components), one or more of the separate components may be shared among several network nodes. For example, a single RNC may control multiple NodeBs. In such a scenario, each unique NodeB and RNC pair may in some instances be considered a single separate network node. In some embodiments, the network node QQ300 may be configured to support multiple radio access technologies (RATs). In such embodiments, some components may be duplicated (e.g., separate memory QQ304 for different RATs) and some components may be reused (e.g., a same antenna QQ310 may be shared by different RATs). The network node QQ300 may also include multiple sets of the various illustrated components for different wireless technologies integrated into network node QQ300, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node QQ300.

The processing circuitry QQ302 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node QQ300 components, such as the memory QQ304, to provide network node QQ300 functionality.

In some embodiments, the processing circuitry QQ302 includes a system on a chip (SOC). In some embodiments, the processing circuitry QQ302 includes one or more of radio frequency (RF) transceiver circuitry QQ312 and baseband processing circuitry QQ314. In some embodiments, the radio frequency (RF) transceiver circuitry QQ312 and the baseband processing circuitry QQ314 may be on separate chips (or sets of chips), boards, or units, such as radio units and digital units. In alternative embodiments, part or all of RF transceiver circuitry QQ312 and baseband processing circuitry QQ314 may be on the same chip or set of chips, boards, or units.

The memory QQ304 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry QQ302. The memory QQ304 may store any suitable instructions, data, or information, including a computer program, software, an application including one or more of logic, rules, code, tables, and/or other instructions capable of being executed by the processing circuitry QQ302 and utilized by the network node QQ300. The memory QQ304 may be used to store any calculations made by the processing circuitry QQ302 and/or any data received via the communication interface QQ306. In some embodiments, the processing circuitry QQ302 and memory QQ304 is integrated.

The communication interface QQ306 is used in wired or wireless communication of signaling and/or data between a network node, access network, and/or UE. As illustrated, the communication interface QQ306 comprises port(s)/terminal(s) QQ316 to send and receive data, for example to and from a network over a wired connection. The communication interface QQ306 also includes radio front-end circuitry QQ318 that may be coupled to, or in certain embodiments a part of, the antenna QQ310. Radio front-end circuitry QQ318 comprises filters QQ320 and amplifiers QQ322. The radio front-end circuitry QQ318 may be connected to an antenna QQ310 and processing circuitry QQ302. The radio front-end circuitry may be configured to condition signals communicated between antenna QQ310 and processing circuitry QQ302. The radio front-end circuitry QQ318 may receive digital data that is to be sent out to other network nodes or UEs via a wireless connection. The radio front-end circuitry QQ318 may convert the digital data into a radio signal having the appropriate channel and bandwidth parameters using a combination of filters QQ320 and/or amplifiers QQ322. The radio signal may then be transmitted via the antenna QQ310. Similarly, when receiving data, the antenna QQ310 may collect radio signals which are then converted into digital data by the radio front-end circuitry QQ318. The digital data may be passed to the processing circuitry QQ302. In other embodiments, the communication interface may comprise different components and/or different combinations of components.

In certain alternative embodiments, the network node QQ300 does not include separate radio front-end circuitry QQ318, instead, the processing circuitry QQ302 includes radio front-end circuitry and is connected to the antenna QQ310. Similarly, in some embodiments, all or some of the RF transceiver circuitry QQ312 is part of the communication interface QQ306. In still other embodiments, the communication interface QQ306 includes one or more ports or terminals QQ316, the radio front-end circuitry QQ318, and the RF transceiver circuitry QQ312, as part of a radio unit (not shown), and the communication interface QQ306 communicates with the baseband processing circuitry QQ314, which is part of a digital unit (not shown).

The antenna QQ310 may include one or more antennas, or antenna arrays, configured to send and/or receive wireless signals. The antenna QQ310 may be coupled to the radio front-end circuitry QQ318 and may be any type of antenna capable of transmitting and receiving data and/or signals wirelessly. In certain embodiments, the antenna QQ310 is separate from the network node QQ300 and connectable to the network node QQ300 through an interface or port.

The antenna QQ310, communication interface QQ306, and/or the processing circuitry QQ302 may be configured to perform any receiving operations and/or certain obtaining operations described herein as being performed by the network node. Any information, data and/or signals may be received from a UE, another network node and/or any other network equipment. Similarly, the antenna QQ310, the communication interface QQ306, and/or the processing circuitry QQ302 may be configured to perform any transmitting operations described herein as being performed by the network node. Any information, data and/or signals may be transmitted to a UE, another network node and/or any other network equipment.

The power source QQ308 provides power to the various components of network node QQ300 in a form suitable for the respective components (e.g., at a voltage and current level needed for each respective component). The power source QQ308 may further comprise, or be coupled to, power management circuitry to supply the components of the network node QQ300 with power for performing the functionality described herein. For example, the network node QQ300 may be connectable to an external power source (e.g., the power grid, an electricity outlet) via an input circuitry or interface such as an electrical cable, whereby the external power source supplies power to power circuitry of the power source QQ308. As a further example, the power source QQ308 may comprise a source of power in the form of a battery or battery pack which is connected to, or integrated in, power circuitry. The battery may provide backup power should the external power source fail.

Embodiments of the network node QQ300 may include additional components beyond those shown in Figure QQ3 for providing certain aspects of the network node's functionality, including any of the functionality described herein and/or any functionality necessary to support the subject matter described herein. For example, the network node QQ300 may include user interface equipment to allow input of information into the network node QQ300 and to allow output of information from the network node QQ300. This may allow a user to perform diagnostic, maintenance, repair, and other administrative functions for the network node QQ300.

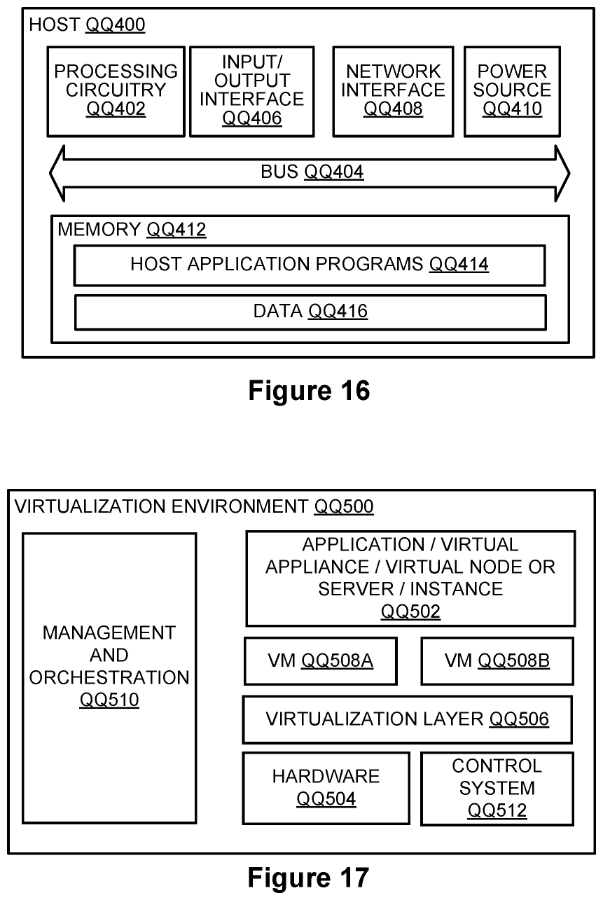

FIG. 16 is a block diagram of a host QQ400, which may be an embodiment of the host QQ116 of FIG. 13, in accordance with various aspects described herein. As used herein, the host QQ400 may be or comprise various combinations hardware and/or software, including a standalone server, a blade server, a cloud-implemented server, a distributed server, a virtual machine, container, or processing resources in a server farm. The host QQ400 may provide one or more services to one or more UEs.

The host QQ400 includes processing circuitry QQ402 that is operatively coupled via a bus QQ404 to an input/output interface QQ406, a network interface QQ408, a power source QQ410, and a memory QQ412. Other components may be included in other embodiments. Features of these components may be substantially similar to those described with respect to the devices of previous figures, such as FIGS. 14 and 15, such that the descriptions thereof are generally applicable to the corresponding components of host QQ400.

The memory QQ412 may include one or more computer programs including one or more host application programs QQ414 and data QQ416, which may include user data, e.g., data generated by a UE for the host QQ400 or data generated by the host QQ400 for a UE. Embodiments of the host QQ400 may utilize only a subset or all of the components shown. The host application programs QQ414 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs QQ414 may also provide for user authentication and licensing checks and may periodically report health, routes, and content availability to a central node, such as a device in or on the edge of a core network. Accordingly, the host QQ400 may select and/or indicate a different host for over-the-top services for a UE. The host application programs QQ414 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 17 is a block diagram illustrating a virtualization environment QQ500 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments QQ500 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications QQ502 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware QQ504 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers QQ506 (also referred to as hypervisors or virtual machine monitors (VMMs)), provide VMs QQ508a and QQ508b (one or more of which may be generally referred to as VMs QQ508), and/or perform any of the functions, features and/or benefits described in relation with some embodiments described herein. The virtualization layer QQ506 may present a virtual operating platform that appears like networking hardware to the VMs QQ508.

The VMs QQ508 comprise virtual processing, virtual memory, virtual networking or interface and virtual storage, and may be run by a corresponding virtualization layer QQ506. Different embodiments of the instance of a virtual appliance QQ502 may be implemented on one or more of VMs QQ508, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM QQ508 may be a software implementation of a physical machine that runs programs as if they were executing on a physical, non-virtualized machine. Each of the VMs QQ508, and that part of hardware QQ504 that executes that VM, be it hardware dedicated to that VM and/or hardware shared by that VM with others of the VMs, forms separate virtual network elements. Still in the context of NFV, a virtual network function is responsible for handling specific network functions that run in one or more VMs QQ508 on top of the hardware QQ504 and corresponds to the application QQ502.

Hardware QQ504 may be implemented in a standalone network node with generic or specific components. Hardware QQ504 may implement some functions via virtualization. Alternatively, hardware QQ504 may be part of a larger cluster of hardware (e.g. such as in a data center or CPE) where many hardware nodes work together and are managed via management and orchestration QQ510, which, among others, oversees lifecycle management of applications QQ502. In some embodiments, hardware QQ504 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system QQ512 which may alternatively be used for communication between hardware nodes and radio units.

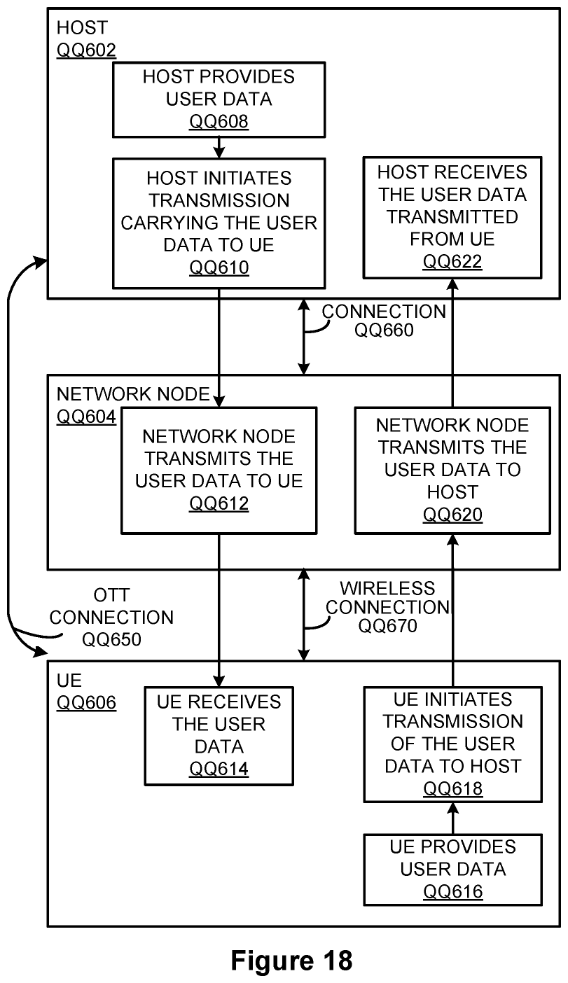

FIG. 18 shows a communication diagram of a host QQ602 communicating via a network node QQ604 with a UE QQ606 over a partially wireless connection in accordance with some embodiments. Example implementations, in accordance with various embodiments, of the UE (such as a UE QQ112a of FIG. 13 and/or UE QQ200 of FIG. 14), network node (such as network node QQ110a of FIG. 13 and/or network node QQ300 of FIG. 15), and host (such as host QQ116 of FIG. 13 and/or host QQ400 of FIG. 16) discussed in the preceding paragraphs will now be described with reference to FIG. 16.

Like host QQ400, embodiments of host QQ602 include hardware, such as a communication interface, processing circuitry, and memory. The host QQ602 also includes software, which is stored in or accessible by the host QQ602 and executable by the processing circuitry. The software includes a host application that may be operable to provide a service to a remote user, such as the UE QQ606 connecting via an over-the-top (OTT) connection QQ650 extending between the UE QQ606 and host QQ602. In providing the service to the remote user, a host application may provide user data which is transmitted using the OTT connection QQ650.

The network node QQ604 includes hardware enabling it to communicate with the host QQ602 and UE QQ606. The connection QQ660 may be direct or pass through a core network (like core network QQ106 of FIG. 13) and/or one or more other intermediate networks, such as one or more public, private, or hosted networks. For example, an intermediate network may be a backbone network or the Internet.

The UE QQ606 includes hardware and software, which is stored in or accessible by UE QQ606 and executable by the UE's processing circuitry. The software includes a client application, such as a web browser or operator-specific “app” that may be operable to provide a service to a human or non-human user via UE QQ606 with the support of the host QQ602. In the host QQ602, an executing host application may communicate with the executing client application via the OTT connection QQ650 terminating at the UE QQ606 and host QQ602. In providing the service to the user, the UE's client application may receive request data from the host's host application and provide user data in response to the request data. The OTT connection QQ650 may transfer both the request data and the user data. The UE's client application may interact with the user to generate the user data that it provides to the host application through the OTT connection QQ650.

The OTT connection QQ650 may extend via a connection QQ660 between the host QQ602 and the network node QQ604 and via a wireless connection QQ670 between the network node QQ604 and the UE QQ606 to provide the connection between the host QQ602 and the UE QQ606. The connection QQ660 and wireless connection QQ670, over which the OTT connection QQ650 may be provided, have been drawn abstractly to illustrate the communication between the host QQ602 and the UE QQ606 via the network node QQ604, without explicit reference to any intermediary devices and the precise routing of messages via these devices.

As an example of transmitting data via the OTT connection QQ650, in step QQ608, the host QQ602 provides user data, which may be performed by executing a host application. In some embodiments, the user data is associated with a particular human user interacting with the UE QQ606. In other embodiments, the user data is associated with a UE QQ606 that shares data with the host QQ602 without explicit human interaction. In step QQ610, the host QQ602 initiates a transmission carrying the user data towards the UE QQ606. The host QQ602 may initiate the transmission responsive to a request transmitted by the UE QQ606. The request may be caused by human interaction with the UE QQ606 or by operation of the client application executing on the UE QQ606. The transmission may pass via the network node QQ604, in accordance with the teachings of the embodiments described throughout this disclosure. Accordingly, in step QQ612, the network node QQ604 transmits to the UE QQ606 the user data that was carried in the transmission that the host QQ602 initiated, in accordance with the teachings of the embodiments described throughout this disclosure. In step QQ614, the UE QQ606 receives the user data carried in the transmission, which may be performed by a client application executed on the UE QQ606 associated with the host application executed by the host QQ602.

In some examples, the UE QQ606 executes a client application which provides user data to the host QQ602. The user data may be provided in reaction or response to the data received from the host QQ602. Accordingly, in step QQ616, the UE QQ606 may provide user data, which may be performed by executing the client application. In providing the user data, the client application may further consider user input received from the user via an input/output interface of the UE QQ606. Regardless of the specific manner in which the user data was provided, the UE QQ606 initiates, in step QQ618, transmission of the user data towards the host QQ602 via the network node QQ604. In step QQ620, in accordance with the teachings of the embodiments described throughout this disclosure, the network node QQ604 receives user data from the UE QQ606 and initiates transmission of the received user data towards the host QQ602. In step QQ622, the host QQ602 receives the user data carried in the transmission initiated by the UE QQ606.

In an example scenario, factory status information may be collected and analyzed by the host QQ602. As another example, the host QQ602 may process audio and video data which may have been retrieved from a UE for use in creating maps. As another example, the host QQ602 may collect and analyze real-time data to assist in controlling vehicle congestion (e.g., controlling traffic lights). As another example, the host QQ602 may store surveillance video uploaded by a UE. As another example, the host QQ602 may store or control access to media content such as video, audio, VR or AR which it can broadcast, multicast or unicast to UEs. As other examples, the host QQ602 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which one or more embodiments improve. There may further be an optional network functionality for reconfiguring the OTT connection QQ650 between the host QQ602 and UE QQ606, in response to variations in the measurement results. The measurement procedure and/or the network functionality for reconfiguring the OTT connection may be implemented in software and hardware of the host QQ602 and/or UE QQ606. In some embodiments, sensors (not shown) may be deployed in or in association with other devices through which the OTT connection QQ650 passes; the sensors may participate in the measurement procedure by supplying values of the monitored quantities exemplified above, or supplying values of other physical quantities from which software may compute or estimate the monitored quantities. The reconfiguring of the OTT connection QQ650 may include message format, retransmission settings, preferred routing etc.; the reconfiguring need not directly alter the operation of the network node QQ604. Such procedures and functionalities may be known and practiced in the art. In certain embodiments, measurements may involve proprietary UE signaling that facilitates measurements of throughput, propagation times, latency and the like, by the host QQ602. The measurements may be implemented in that software causes messages to be transmitted, in particular empty or ‘dummy’ messages, using the OTT connection QQ650 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

For further clarification and to facilitate understanding of the present disclosure, a listing of example Embodiments is provided below:

1. A method performed by a network node for precoding of downlink communications predicting downlink channel state, the method comprising:
receiving (1200), from a user equipment, a compressed-dimensional representation of a forward channel state at a time k generated from a multi-dimensional representation of the forward channel state at the time k encoded through an encoder neural network of the user equipment, wherein the multi-dimensional representation is a higher dimensional representation than the compressed-dimensional representation;
mapping (1202) the compressed-dimensional representation of the forward channel state at the time k through a forward-prediction neural network to generate a compressed-dimensional predicted representation of the forward channel state at least one step forward in time k+Δ, wherein Δ is a number of steps forward in time;
decoding (1204) the compressed-dimensional predicted representation of the forward channel state through a decoding neural network to generate an increased-dimensional predicted representation of the forward channel state at least one step forward in time k+Δ, wherein the increased-dimensional predicted representation is a higher dimensional representation than the compressed-dimensional predicted representation; and
precoding (1206) signals for transmission through the downlink channel to the user equipment based on the increased-dimensional predicted representation of the forward channel state.

2. The method of Embodiment 1, wherein the mapping (1202) the compressed-dimensional representation of the forward channel state at the time k through the forward-prediction neural network to generate the compressed-dimensional predicted representation of the forward channel state at least one step forward in time k+Δ, comprises:
repeating for each step-ahead prediction in a recursive manner from time k to time k+Δ,
feeding output by the forward-prediction neural network from the previous step, the compressed-dimensional predicted representation of the forward channel state for the step forward in time as an input to the forward-prediction neural network to generate a compressed-dimensional predicted representation of the forward channel state for a next step forward in time.

3. The method of Embodiment 1, wherein the forward-prediction neural network comprises a plurality of daisy changed stages, and the mapping (1202) the compressed-dimensional representation of the forward channel state at the time k through the forward-prediction neural network to generate the compressed-dimensional predicted representation of the forward channel state at least one step forward in time k+Δ, comprises:
for each step-ahead prediction Δ time,
feeding output by a previous stage of the forward-prediction neural network as an input to a next stage of the forward-prediction neural network to generate a compressed-dimensional predicted representation of the forward channel state for a next step forward in time.

4. The method of any of Embodiments 1 to 3, further comprising:
determining the number of steps m forward in time based on a first slot time, a number of slot steps, and a last slot time, relative to the time k, to be included in the compressed-dimensional predicted representation of the forward channel state.

5. The method of any of Embodiments 1 to 4, further comprising:
pre-training parameters of the encoding neural network and decoding neural network based on a data feedback loop through the encoding neural network and the decoding neural network to reduce error in the generation of the increased-dimensional representation of the forward channel state; and
training parameters of the forward-prediction neural network based on another data feedback loop through the encoding neural network, the forward-prediction neural network, and the decoding neural network to reduce error in the generation of the compressed-dimensional predicted representation of the forward channel state while parameters of the encoding neural network and the decoding neural network are fixed.

6. The method of any of Embodiments 1 to 5, wherein:
the decoding neural network is trained to approximate an inverse transformation of the encoder neural network.

7. The method of any of Embodiments 1 to 6, wherein the precoding (1206) of signals for transmission through the downlink channel to the user equipment based on the increased-dimensional predicted representation of the forward channel state, comprises:
computing a precoding vector or matrix for transmission of a data channel and/or a control channel to the user equipment.

8. The method of any of Embodiments 1 to 7, further comprising:
determining from capability information received from the user equipment that the user equipment supports prediction of the forward channel state.

9. The method of Embodiment 8, wherein the determining from the capability information received from the user equipment that the user equipment supports prediction of the forward channel state, further comprises determining how many steps m forward in time of prediction are supported by the user equipment.

10. The method of any of Embodiments 8 to 9, further comprising:
receiving the capability information from the user equipment through an uplink shared data channel, uplink control information message, or Medium Access Control Control Element message.

11. The method of any of Embodiments 8 to 10, further comprising:
configuring channel state information, CSI, reporting by the user equipment based on the user equipment determined to support prediction of the forward channel state.

12. The method of Embodiment 11, wherein the configuring CSI reporting by the user equipment based on the user equipment determined to support prediction of the forward channel state, comprises:
configuring how many steps m forward in time the user equipment provides reporting for prediction of the forward channel state.

13. The method of any of Embodiments 11 to 12, wherein the configuring CSI reporting by the user equipment based on the user equipment determined to support prediction of the forward channel state, comprises:
sending control information configured to control the user equipment to aggregate measurements on reference signals, RS, from a plurality of orthogonal frequency-division multiplexing, OFDM, symbols in one or more slots.

14. A method performed by a user equipment for predicting downlink channel state, the method comprising:
obtaining (1100) a multi-dimensional representation of a forward channel state based on channel estimations of signals received from at least one network node;
encoding (1102) the multi-dimensional representation of the forward channel state through an encoder neural network to a compressed-dimensional representation of the forward channel state at a time k, wherein the multi-dimensional representation is a higher dimensional representation than the compressed-dimensional representation;
mapping (1104) the compressed-dimensional representation of the forward channel state at the time k through a forward-prediction neural network to generate a compressed-dimensional predicted representation of the forward channel state at least one step forward in time k+Δ, wherein Δ is a number of steps forward in time; and
sending (1106) the compressed-dimensional predicted representation of the forward channel state to one of the at least one network node.

15. The method any of Embodiment 14, wherein the mapping (1104) of the compressed-dimensional representation of the forward channel state at the time k through the forward-prediction neural network to generate the compressed-dimensional predicted representation of the forward channel state at least one step forward in time k+Δ, comprises:
repeating for each step-ahead prediction Δ time,
   feeding output by the forward-prediction neural network from the previous step, the compressed-dimensional predicted representation of the forward channel state for step forward in time as an input to the forward-prediction neural network to generate a compressed-dimensional predicted representation of the forward channel state for a next step forward in time.

16. The method any of Embodiments 14 to 15, wherein the forward-prediction neural network comprises a plurality of daisy changed stages, and the mapping (1104) of the compressed-dimensional representation of the forward channel state at the time k through the forward-prediction neural network to generate the compressed-dimensional predicted representation of the forward channel state at least one step forward in time k+Δ, comprises:
for each step-ahead prediction Δ time,
   feeding output by a previous stage of the forward-prediction neural network as an input to a next stage of the forward-prediction neural network to generate a compressed-dimensional predicted representation of the forward channel state for a next step forward in time.

17. The method of any of Embodiments 14 to 16, wherein:
the multi-dimensional representation of the forward channel state is obtained based on channel estimations of reference signals or pilot signals received from the at least one network node in time-frequency resource elements, REs, of a multiple-carrier slot-based channel.

18. The method of any of Embodiments 14 to 17, further comprising:
training parameters of the forward-prediction neural network to model time-variation in the forward channel state for a 3GPP CSI feedback mechanism from the user equipment to the one of the at least one network node.

19. The method of any of Embodiments 14 to 18, further comprising:
sending to the one of the at least one network node an indication that the user equipment supports generation of predicted representations of the forward channel state.

20. The method of Embodiment 19, wherein the sending to the one of the at least one network node of the indication that the user equipment supports generation of predicted representations of the forward channel state, further comprises indicating how many steps m forward in time of prediction are supported.

21. The method of any of Embodiments 19 to 20, further comprising:
configuring how many steps m forward in time of prediction the user equipment performs based on control information configuring channel state information, CSI, reporting by the user equipment.

22. The method of any of Embodiments 19 to 21, wherein:
the indication that the user equipment supports generation of predicted representations of the forward channel state, is sent through an uplink shared data channel, uplink control information message, or Medium Access Control Control Element message.

23. A network node for precoding of downlink communications predicting downlink channel state, the network node comprising:
processing circuitry configured to perform any of the steps of the methods of Embodiments 1 to 13; and
a communication interface configured to communicate with a user equipment.

24. A user equipment (UE) for predicting downlink channel state, the UE comprising:
an antenna configured to send and receive wireless signals;
radio front-end circuitry connected to the antenna and configured to condition signals communicated between the antenna and the processing circuitry; and
processing circuitry connected to the radio front-end circuitry and being configured to perform any of the steps of the methods of Embodiments 14 to 22.

1.-33. (canceled)

34. A method performed by a network node for precoding of downlink communications predicting downlink channel state, the method comprising:
receiving, from a user equipment, a compressed-dimensional representation of a channel state generated from a multi-dimensional representation of a channel state at a time k that is encoded through an encoder neural network of the user equipment, wherein the multi-dimensional representation is a higher dimensional representation than the compressed-dimensional representation;
mapping the compressed-dimensional representation of the channel state through a forward-prediction neural network to generate a compressed-dimensional predicted representation of a forward channel state at least one step forward in time k+Δ, wherein Δ is a number of steps forward in time;
decoding the compressed-dimensional predicted representation of the forward channel state through a decoding neural network to generate an increased-dimensional predicted representation of the forward channel state, wherein the increased-dimensional predicted representation is a higher dimensional representation than the compressed-dimensional predicted representation; and
precoding signals for transmission through the downlink channel to the user equipment based on the increased-dimensional predicted representation of the forward channel state.

35. The method of claim 34, wherein the mapping the compressed-dimensional representation of the channel state at the time k through the forward-prediction neural network to generate the compressed-dimensional predicted representation of the forward channel state at least one step forward in time k+Δ, comprises:
repeating for each step-ahead prediction in a recursive manner from time k to time k+Δ,
feeding output by the forward-prediction neural network from the previous step, the compressed-dimensional predicted representation of the forward channel state for the step forward in time as an input to the forward-prediction neural network to generate a compressed-dimensional predicted representation of the forward channel state for a next step forward in time.

36. The method of claim 34, wherein the forward-prediction neural network comprises a plurality of daisy changed stages, and the mapping the compressed-dimensional representation of the channel state at the time k through the forward-prediction neural network to generate the compressed-dimensional predicted representation of the forward channel state at least one step forward in time k+Δ, comprises:
for each step-ahead prediction Δ time,
feeding output by a previous stage of the forward-prediction neural network as an input to a next stage of the forward-prediction neural network to generate a compressed-dimensional predicted representation of the forward channel state for a next step forward in time.

37. The method of claim 34, further comprising:
pre-training parameters of the encoding neural network and decoding neural network based on a data feedback loop through the encoding neural network and the decoding neural network to reduce error in the generation of the increased-dimensional representation of a forward channel state; and
training parameters of the forward-prediction neural network based on another data feedback loop through the encoding neural network, the forward-prediction neural network, and the decoding neural network to reduce error in the generation of the compressed-dimensional predicted representation of a forward channel state while parameters of the encoding neural network and the decoding neural network are fixed.

38. The method of claim 34, further comprising:
pre-training parameters of the encoding neural network and decoding neural network based on a data feedback loop through the encoding neural network and the decoding neural network to reduce error in the generation of the increased-dimensional representation of a forward channel state at least one step forward in time k+Δ₁, wherein Δ₁ is a number of steps forward in time; and
training parameters of the forward-prediction neural network based on another data feedback loop through the encoding neural network, the forward-prediction neural network, and the decoding neural network to reduce error in the generation of the compressed-dimensional predicted representation of a further channel state at least two steps time k+Δ₁+Δ₂, wherein Δ₂ is a number of steps forward in time, while parameters of the encoding neural network and the decoding neural network are fixed.

39. The method of claim 34, wherein the precoding of signals for transmission through the downlink channel to the user equipment based on the increased-dimensional predicted representation of the forward channel state, comprises:
computing a precoding vector or matrix for transmission of a data channel and/or a control channel to the user equipment.

40. The method of claim 34, further comprising:
determining from capability information received from the user equipment that the user equipment supports prediction of a forward channel state, further wherein the determining from the capability information received from the user equipment that the user equipment supports prediction of a forward channel state, further comprises determining how many steps m forward in time of prediction are supported by the user equipment.

41. The method of claim 40, further comprising:
receiving the capability information from the user equipment through an uplink shared data channel, uplink control information message, or Medium Access Control Control Element message.

42. The method of claim 40, further comprising:
configuring channel state information, CSI, reporting by the user equipment based on the user equipment determined to support prediction of a forward channel state, further wherein the configuring CSI reporting by the user equipment based on the user equipment determined to support prediction of a forward channel state, comprises at least one of:
configuring how many steps m forward in time the user equipment provides reporting for prediction of a forward channel state; and
sending control information configured to control the user equipment to aggregate measurements on reference signals, RS, from a plurality of orthogonal frequency-division multiplexing, OFDM, symbols in one or more slots.

43. The method of claim 34, wherein:
the multi-dimensional representation of the channel state is obtained based on channel estimations of reference signals or pilot signals received from the network node in time-frequency resource elements, REs, of a multiple-carrier slot-based channel.

44. A method performed by a user equipment, UE, for predicting downlink channel state, the method comprising:
obtaining a multi-dimensional representation of a channel state based on channel estimations of signals received from at least one network node;
encoding the multi-dimensional representation of the channel state through an encoder neural network to a compressed-dimensional representation of the channel state at a time k, wherein the multi-dimensional representation is a higher dimensional representation than the compressed-dimensional representation;
mapping the compressed-dimensional representation of the channel state at the time k through a forward-prediction neural network to generate a compressed-dimensional predicted representation of a forward channel state at least one step forward in time k+Δ, wherein Δ is a number of steps forward in time; and
sending the compressed-dimensional predicted representation of the forward channel state to one of the at least one network node.

45. The method of claim 44, wherein the mapping of the compressed-dimensional representation of the channel state at the time k through the forward-prediction neural network to generate the compressed-dimensional predicted representation of the forward channel state at least one step forward in time k+Δ, comprises:
repeating for each step-ahead prediction Δ time,
feeding output by the forward-prediction neural network from the previous step, the compressed-dimensional predicted representation of the forward channel state for step forward in time as an input to the forward-prediction neural network to generate a compressed-dimensional predicted representation of the forward channel state for a next step forward in time.

46. The method of claim 44, wherein the forward-prediction neural network comprises a plurality of daisy changed stages, and the mapping of the compressed-dimensional representation of the channel state at the time k through the forward-prediction neural network to generate the compressed-dimensional predicted representation of the forward channel state at least one step forward in time k+Δ, comprises:
for each step-ahead prediction Δ time,
feeding output by a previous stage of the forward-prediction neural network as an input to a next stage of the forward-prediction neural network to generate a compressed-dimensional predicted representation of the forward channel state for a next step forward in time.

47. The method of claim 44, wherein:
the multi-dimensional representation of the forward channel state is obtained based on channel estimations of reference signals or pilot signals received from the at least one network node in time-frequency resource elements, REs, of a multiple-carrier slot-based channel.

48. The method of claim 44, further comprising:
training parameters of the forward-prediction neural network to model time-variation in the forward channel state for a 3GPP CSI feedback mechanism from the user equipment to the one of the at least one network node.

49. The method of claim 44, further comprising:
sending to the one of the at least one network node an indication that the user equipment supports generation of predicted representations of the forward channel state, further wherein the sending to the one of the at least one network node of the indication that the user equipment supports generation of predicted representations of the forward channel state, further comprises indicating how many steps m forward in time of prediction are supported.

50. The method of claim 49, further comprising:
configuring how many steps m forward in time of prediction the user equipment performs based on control information configuring channel state information, CSI, reporting by the user equipment.

51. The method of claim 49, wherein:
the indication that the user equipment supports generation of predicted representations of the forward channel state, is sent through an uplink shared data channel, uplink control information message, or Medium Access Control Control Element message.

52. A network node for precoding of downlink communications predicting downlink channel state, the network node comprising:
a communication interface configured to communicate with a user equipment (UE); and
processing circuitry configured to;
receive, from the user equipment, a compressed-dimensional representation of a channel state generated from a multi-dimensional representation of a channel state at a time k that is encoded through an encoder neural network of the user equipment, wherein the multi-dimensional representation is a higher dimensional representation than the compressed-dimensional representation;
map the compressed-dimensional representation of the channel state through a forward-prediction neural network to generate a compressed-dimensional predicted representation of a forward channel state at least one step forward in time k+Δ, wherein Δ is a number of steps forward in time;
decode the compressed-dimensional predicted representation of the forward channel state through a decoding neural network to generate an increased-dimensional predicted representation of the forward channel state, wherein the increased-dimensional predicted representation is a higher dimensional representation than the compressed-dimensional predicted representation; and
precode signals for transmission through the downlink channel to the user equipment based on the increased-dimensional predicted representation of the forward channel state.

53. A user equipment (UE) for predicting downlink channel state, the UE comprising:
an antenna configured to send and receive wireless signals;
radio front-end circuitry connected to the antenna and configured to condition signals communicated between the antenna and the processing circuitry; and
processing circuitry connected to the radio front-end circuitry and being configured to:
obtain a multi-dimensional representation of a channel state based on channel estimations of signals received from at least one network node;
encode the multi-dimensional representation of the channel state through an encoder neural network to a compressed-dimensional representation of the channel state at a time k, wherein the multi-dimensional representation is a higher dimensional representation than the compressed-dimensional representation;
map the compressed-dimensional representation of the channel state at the time k through a forward-prediction neural network to generate a compressed-dimensional predicted representation of a forward channel state at least one step forward in time k+Δ, wherein Δ is a number of steps forward in time; and
send the compressed-dimensional predicted representation of the forward channel state to one of the at least one network node.
